(19) United States
(12) Patent Application Publication
(10) Pub. No.: US 2026/0112822 A1
(43) Pub. Date: Apr. 23, 2026

(54) ANTENNA SUBSTRATE AND ANTENNA DEVICE

(71) Applicants: Murata Manufacturing Co., Ltd., Nagaokakyo-shi (JP); Dai Nippon Printing Co., Ltd., Tokyo (JP)

(72) Inventors: Kaoru SUDO, Nagaokakyo-shi (JP); Hideki UEDA, Nagaokakyo-shi (JP); Shuji KAWAGUCHI, Tokyo (JP); Kazuki KINOSHITA, Tokyo (JP)

(73) Assignees: Murata Manufacturing Co., Ltd., Nagaokakyo-shi (JP); Dai Nippon Printing Co., Ltd., Tokyo (JP)

(21) Appl. No.: 19/428,362

(22) Filed: Dec. 22, 2025

Related U.S. Application Data
(63) Continuation of application No. PCT/JP2024/020878, filed on Jun. 7, 2024.

(30) Foreign Application Priority Data
Jul. 3, 2023 (JP) 2023-109396

(51) Int. Cl. H01Q 21/24; H01Q 5/307; H01Q 13/08

(52) U.S. Cl. CPC H01Q 21/24; H01Q 5/307; H01Q 13/08

(57) ABSTRACT

An antenna substrate includes a dielectric substrate having a main surface; and first to third planar radiation electrodes and first and second feed lines located on the main surface of the dielectric substrate. A size difference between the first and second radiation electrodes and a size difference between the first and third radiation electrodes are larger than a size difference between the second and third radiation electrodes. The first and second feed lines are connected to at least one of the first to third radiation electrode at first and second connection points different from each other. The first radiation electrode is adjacent to the second radiation electrode in a first direction and is adjacent to the third radiation electrode in a second direction different from the first direction.

### CROSS-REFERENCE TO RELATED APPLICATIONS

This application is a continuation of International Application No. PCT/JP2024/020878, filed on Jun. 7, 2024, which claims priority to Japanese Patent Application No. 2023-109396, filed on Jul. 3, 2023. The entire disclosures of the prior applications are hereby incorporated by reference in their entirety.

### TECHNICAL FIELD

The present disclosure relates to an antenna substrate and an antenna device.

### BACKGROUND ART

Antenna Theory and Design, W. L. Stutzman & G. A. Thiele, John Wiley and Sons, 1981, pp 295-303 discloses a configuration example of an antenna corresponding to a plurality of frequency bands. In Antenna Theory and Design, W. L. Stutzman & G. A. Thiele, John Wiley and Sons, 1981, pp 295-303, a first square patch appropriate for a first frequency, a first feed line connected to the first square patch, and a second square patch connected to the first square patch via a second feed line are formed on a substrate.

### Non-patent Document

Non-patent Document 1: Antenna Theory and Design, W. L. Stutzman & G. A. Thiele, John Wiley and Sons, 1981, pp 295-303

### SUMMARY

According to an aspect of the present disclosure, an antenna substrate includes a dielectric substrate having a main surface; and first to third planar radiation electrodes and first and second feed lines located on the main surface of the dielectric substrate. A size difference between the first and second radiation electrodes and a size difference between the first and third radiation electrodes are larger than a size difference between the second and third radiation electrodes The first and second feed lines are connected to the first radiation electrode at first and second connection points different from each other. The first radiation electrode is adjacent to the second radiation electrode in a first direction intersecting a direction of a first linear line connecting the first connection point to a center of the first radiation electrode within the main surface, intersects a direction of a second linear line connecting the second connection point to a center of the first radiation electrode within the main surface, and is adjacent to the third radiation electrode in a second direction different from the first direction.

According to an aspect of the present disclosure, an antenna substrate includes a dielectric substrate having a main surface; and first to third planar radiation electrodes and first and second feed lines located on the main surface of the dielectric substrate. A size difference between the first and second radiation electrodes and a size difference between the first and third radiation electrodes are larger than a size difference between the second and third radiation electrodes The first feed line is connected to the second radiation electrode at a first connection point. The second feed line is connected to the third radiation electrode at the second connection point. The first radiation electrode is adjacent to one of the second and third radiation electrodes in a first direction intersecting a first linear line connecting the first connection point to a center of the second radiation electrode within the main surface, intersects a second linear line connecting the second connection point and a center of the third radiation electrode within the main surface, and is adjacent to the other of the second and third radiation electrodes in a second direction different from the first direction.

According to another aspect of the present disclosure, an antenna device includes any one of the antenna substrates; and a grounding electrode on a side opposite to the main surface in the dielectric substrate.

### BRIEF DESCRIPTION OF DRAWINGS

FIG. 1 is a perspective view of an antenna substrate according to a first embodiment;

FIG. 2 is a plan view of the antenna substrate according to the first embodiment;

FIG. 3 is a plan view of an antenna substrate according to a second embodiment;

FIG. 4 is a plan view of an antenna substrate according to a third embodiment;

FIG. 5 is a plan view of an antenna substrate according to a fourth embodiment;

FIG. 6 is a plan view of an antenna substrate according to a fifth embodiment;

FIG. 7 is a plan view of an antenna substrate according to a sixth embodiment;

FIG. 8 is a plan view of an antenna substrate according to a seventh embodiment;

FIG. 9 is a plan view of an antenna substrate according to an eighth embodiment;

FIG. 10 is a plan view of an antenna substrate according to a ninth embodiment;

FIG. 11 is an enlarged view of an antenna substrate according to a tenth embodiment;

FIG. 12 is an enlarged view of an antenna substrate according to an eleventh embodiment; and

FIG. 13 is a perspective view of an antenna device according to a twelfth embodiment.

### DETAILED DESCRIPTION

According to the technique described in Antenna Theory and Design, W. L. Stutzman & G. A. Thiele, John Wiley and Sons, 1981, pp 295-303, a dual-polarized antenna corresponding to a plurality of frequencies can be configured by arranging two sets of the first square patch, the first feed line, and the first square patch such that arrangement directions thereof are orthogonal to each other. However, a plurality of square patches (radiation electrodes) are required for each polarized wave, and an area required for disposing the radiation electrodes increases.

The present disclosure provides an antenna substrate and an antenna device that can be applied to a dual-polarized antenna corresponding to a plurality of frequency bands and can reduce an area required for disposing a radiation electrode.

The aspects of the present disclosure, described in detail below, can be applied to a dual-polarized antenna corresponding to a plurality of frequency bands, and an area required for disposing a radiation electrode may be reduced.

### 1. Embodiments

The embodiments of the present disclosure will be described below, with reference to the drawings where appropriate. However, the embodiments described below are provided merely as examples for explaining the present disclosure, and are not intended to limit the present disclosure to the following contents (for example, the shapes, dimensions, or arrangements of individual components). Unless otherwise specified, positional relationships such as upper, lower, left, and right are based on those shown in the drawings. The drawings described in the embodiments below are schematic illustrations, and the proportions of the size and thickness of the individual components depicted therein do not necessarily reflect actual dimensional ratios. Moreover, the dimensional ratios of the components are not limited to those illustrated in the drawings.

In the following description, when it is necessary to distinguish among a plurality of components, prefixes such as “first” and “second” are attached to the names of the components. However, when the components can be distinguished from one another by the reference signs assigned to them, such prefixes may be omitted to improve readability.

In the following description, for the sake of simplicity, the XYZ orthogonal coordinate system shown in the drawings is used.

### 1.1 First Embodiment

### 1.1.1 Configuration

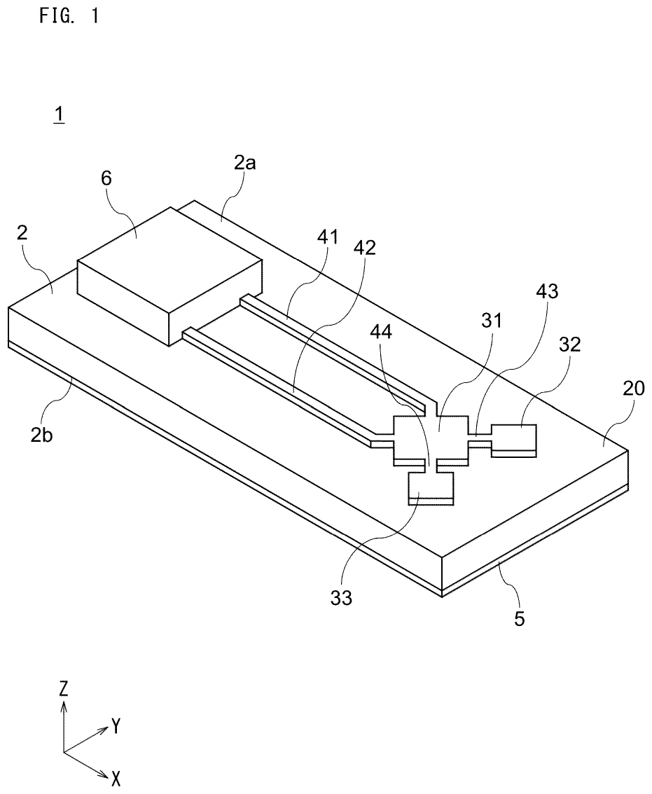

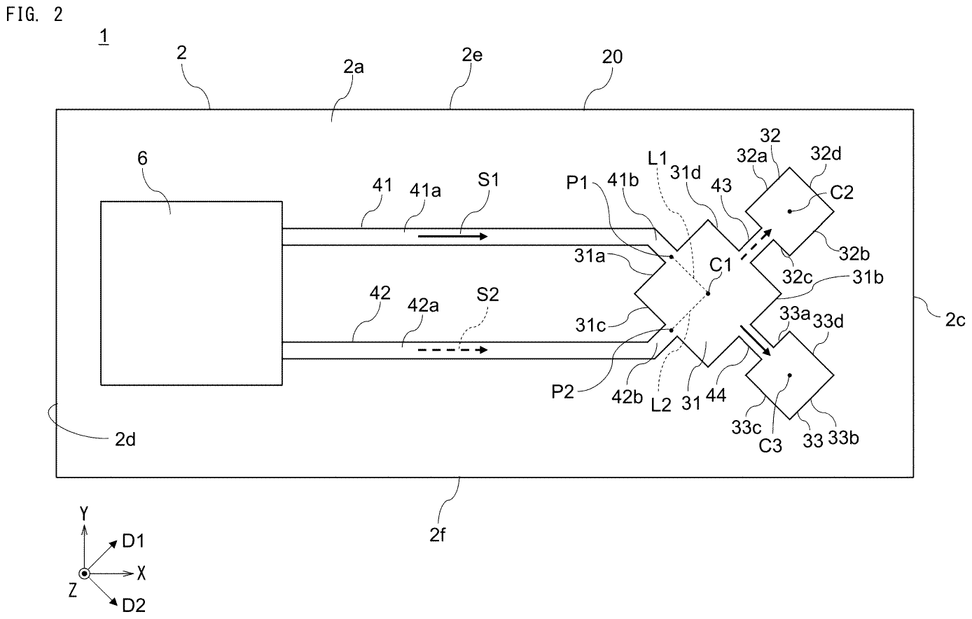

FIG. 1 is a perspective view of an antenna substrate 1 according to a first embodiment. FIG. 2 is a plan view of the antenna substrate 1. The antenna substrate 1 includes a dielectric substrate 2, a first radiation electrode 31, a second radiation electrode 32, a third radiation electrode 33, a first feed line 41, a second feed line 42, a third feed line 43, a fourth feed line 44, a grounding electrode 5, and a processing circuit 6.

The dielectric substrate 2 has a thickness. In the present embodiment, a thickness direction of the dielectric substrate 2 corresponds to the Z direction. The dielectric substrate 2 has a length direction and a width direction orthogonal to the thickness direction. In the present embodiment, the length direction of dielectric substrate 2 corresponds to the X direction, and the width direction of the dielectric substrate 2 corresponds to the Y direction.

The dielectric substrate 2 includes a dielectric layer 20. The dielectric layer 20 has a main surface 2a and a back surface 2b opposite to the main surface 2a. The main surface 2a and the back surface 2b are both surfaces in the thickness direction of the dielectric substrate 2. A normal direction of the main surface 2a matches the thickness direction of the dielectric substrate 2. Therefore, the thickness direction of the dielectric substrate 2 may be referred to as a normal direction of the dielectric substrate 2.

The dielectric substrate 2 has a rectangular plate shape. The dielectric substrate 2 has first and second ends 2c and 2d opposite to each other in the X direction, and third and fourth ends 2e and 2f opposite to each other in the Y direction.

Examples of the dielectric substrate 2 include a low-temperature co-fired ceramic (LTCC) multilayer substrate, a multilayer resin substrate formed by stacking a plurality of resin layers formed of a resin such as epoxy or polyimide, a multilayer resin substrate formed by stacking a plurality of resin layers formed of a liquid crystal polymer (LCP) having a lower dielectric constant, a multilayer resin substrate formed by stacking a plurality of resin layers formed of a fluorine-based resin, and a ceramic multilayer substrate other than LTCC.

The first radiation electrode 31, the second radiation electrode 32, the third radiation electrode 33, the first feed line 41, the second feed line 42, the third feed line 43, the fourth feed line 44, and the processing circuit 6 are located on the main surface 2a of the dielectric substrate 2. In the present embodiment, the first radiation electrode 31, the second radiation electrode 32, the third radiation electrode 33, the first feed line 41, the second feed line 42, the third feed line 43, and the fourth feed line 44 are located on the first end 2c side of the dielectric substrate 2, and the processing circuit 6 is located on the second end 2d side of the dielectric substrate 2.

More specifically, the second and third radiation electrodes 32 and 33 are located on the opposite side of the processing circuit 6 with respect to the first radiation electrode 31. The first and second feed lines 41 and 42 are connected to the first radiation electrode 31.

The first radiation electrode 31 has a planar shape. The first radiation electrode 31 has first and second sides 31a and 31b facing each other, and third and fourth sides 31c and 31d facing each other. When viewed in the thickness direction of dielectric substrate 2, the first radiation electrode 31 has a quadrilateral shape including first to fourth sides 31a to 31d. In the present embodiment, the first to fourth sides 31a to 31d have the same length, and the first radiation electrode 31 has a square shape when viewed in the thickness direction of dielectric substrate 2.

The first and third sides 31a and 31c face the second end 2d side, and the second side 31b and the fourth side 31d face the first end 2c side. The first side 31a and the fourth side 31d face the third end 2e side, and the second and third sides 31b and 31c face the fourth end 2f side. In the present embodiment, a diagonal line between a vertex between the first and third sides 31a and 31c and a vertex between the second and fourth sides 31b and 31d is along the X direction, and a diagonal line between a vertex between the first and fourth sides 31a and 31d and a vertex between the second and third sides 31b and 31c is along the Y direction.

In the first radiation electrode 31, first and second connection points P1 and P2 with the first and second feed lines 41 and 42 are set on the first and third sides 31a and 31c, respectively. The first and second connection points P1 and P2 are virtual points. The first and second connection points P1 and P2 are, for example, midpoints of the first and third sides 31a and 31c.

The first and second feed lines 41 and 42 are connected to the first radiation electrode 31 at different first and second connection points P1 and P2, respectively.

The first feed line 41 connects the processing circuit 6 to the first radiation electrode 31. The first feed line 41 includes first and second portions 41a and 41b. The first portion 41a extends in the X direction from the processing circuit 6 to the first radiation electrode 31. The first portion 41a is not arranged with the first connection point P1 of the first radiation electrode 31 in the Y direction, and is located on the side opposite to the second connection point P2 with respect to the first connection point P1. The second portion 41b extends from an end of the first portion 41a on the first radiation electrode 31 side to the first side 31a of the first radiation electrode 31, and is connected to the first connection point P1. The direction in which the second portion 41b extends matches a direction of a first linear line L1 connecting the first connection point P1 to the center C1 of the first radiation electrode 31. The first linear line L1 is a virtual line.

The second feed line 42 connects the processing circuit 6 to the first radiation electrode 31. The second feed line 42 includes first and second portions 42a and 42b. The first portion 42a extends in the X direction from the processing circuit 6 to the first radiation electrode 31. The first portion 42a is not arranged with the second connection point P2 of the first radiation electrode 31 in the Y direction, and is located on the opposite side to the first connection point P1 with respect to the second connection point P2. The second portion 42b extends from an end of the first portion 42a on the first radiation electrode 31 side to the third side 31c of the first radiation electrode 31, and is connected to the second connection point P2. The direction in which the second portion 42b extends matches a direction of a second linear line L2 connecting the second connection point P2 to the center C1 of the first radiation electrode 31. The second linear line L2 is a virtual line. In the present embodiment, the second linear line L2 is orthogonal to the first linear line L1 within main surface 2a. These virtual lines are geometric references for defining the relative positions of the electrodes, not physical components.

The second radiation electrode 32 has a planar shape. The second radiation electrode 32 has first and second sides 32a and 32b facing each other, and third and fourth sides 32c and 32d facing each other. When viewed in the thickness direction of the dielectric substrate 2, the second radiation electrode 32 has a quadrilateral shape formed by first to fourth sides 32a to 32d. In the present embodiment, the lengths of the first to fourth sides 32a to 32d are equal, and the second radiation electrode 32 has a square shape when viewed in the thickness direction of the dielectric substrate 2.

The first and third sides 32a and 32c face the second end 2d side, and the second and fourth sides 32b and 32d face the first end 2c side. The first and fourth sides 32a and 32d face the third end 2e side, and the second and third sides 32b and 32c face the fourth end 2f side. In the present embodiment, a diagonal line between a vertex between the first and third sides 32a and 32c and a vertex between the second and fourth sides 32b and 32d is along the X direction, and a diagonal line between a vertex between the first and fourth sides 32a and 32d and a vertex between the second and third sides 32b and 32c is along the Y direction.

The second radiation electrode 32 is adjacent to the first radiation electrode 31 in a first direction D1 intersecting the direction of the first linear line L1 within the main surface 2a. In the present embodiment, the first direction D1 is orthogonal to the direction of first linear line L1 within the main surface 2a. Therefore, the first direction D1 and the direction of the second linear line L2 match each other. A center C2 of the second radiation electrode 32 is located on an extension line of the second linear line L2. The third side 32c of the second radiation electrode 32 faces the fourth side 31d of the first radiation electrode 31 with a predetermined distance therebetween. The fourth side 31d of the first radiation electrode 31 and the third side 32c of the second radiation electrode 32 are parallel to each other. The second radiation electrode 32 is coupled to the first radiation electrode 31 by the third side 32c.

The third feed line 43 connects the first radiation electrode 31 to the second radiation electrode 32. Accordingly, the first and second radiation electrodes 31 and 32 are directly connected to each other, and a signal propagates from the first radiation electrode 31 to the second radiation electrode 32. In the present embodiment, the third feed line 43 extends in the first direction D1.

The third radiation electrode 33 has a planar shape. The third radiation electrode 33 has first and second sides 33a and 33b facing each other, and third and fourth sides 33c and 33d facing each other. When viewed in the thickness direction of the dielectric substrate 2, the third radiation electrode 33 has a quadrilateral shape formed by the first side 33a to the fourth side 33d. In the present embodiment, the lengths of the first to fourth sides 33a to 33d are equal, and the third radiation electrode 33 has a square shape when viewed in the thickness direction of dielectric substrate 2.

The first and third sides 33a and 33c face the second end 2d side, and the second side 33b and the fourth side 33d face the first end 2c side. The first and fourth sides 33a and 33d face the third end 2e side, and the second and third sides 33b and 33c face the fourth end 2f side. In the present embodiment, a diagonal line between a vertex between the first and third sides 33a and 33c and a vertex between the second and fourth sides 33b and 33d is along the X direction, and a diagonal line between a vertex between the first and fourth sides 33a and 33d and a vertex between the second and third sides 33b and 33c is along the Y direction.

The third radiation electrode 33 is adjacent to the first radiation electrode 31 in the second direction D2 intersecting the direction of the second linear line L2 within the main surface 2a. In the present embodiment, the second direction D2 is orthogonal to the direction of the second linear line L2 within the main surface 2a. Therefore, the second direction D2 matches the direction of the first linear line L1. A center C3 of the third radiation electrode 33 is located on an extension line of the first linear line L1. The third side 33a of the third radiation electrode 33 faces the second side 31b of the first radiation electrode 31 with a predetermined distance therebetween. The second side 31b of the first radiation electrode 31 and the first side 33a of the third radiation electrode 33 are parallel to each other. The third radiation electrode 33 is coupled to the first radiation electrode 31 by the first side 33a.

The fourth feed line 44 connects the first radiation electrode 31 to the third radiation electrode 33. Accordingly, the first radiation electrode 31 and the third radiation electrode 33 are directly connected to each other, and a signal propagates from the first radiation electrode 31 to the third radiation electrode 33. In the present embodiment, the fourth feed line 44 extends in the second direction D2.

As described above, the first to third radiation electrodes 31 to 33 are arranged such that the first radiation electrode 31 is adjacent to the second radiation electrode 32 in the first direction D1 intersecting the direction of first linear line L1 within the main surface 2a, intersects the direction of second linear line L2 within the main surface 2a, and is adjacent to the third radiation electrode 33 in the second direction D2 different from first direction D1.

In the antenna substrate 1, the first radiation electrode 31, the second radiation electrode 32, and the third radiation electrode 33 are included in a dual-polarized antenna corresponding to a plurality of frequency bands. In the present embodiment, the first radiation electrode 31 has a shape symmetrical with respect to a center line of the first radiation electrode 31 in the X direction, and the second and third radiation electrodes 32 and 33 are disposed symmetrically with respect to the center line of the first radiation electrode 31 in the X direction. Accordingly, in the antenna substrate 1, the symmetry of the arrangement of the first to third planar radiation electrodes 31 to 33 can be improved.

The sizes of the first to third radiation electrodes 31 to 33 are determined according to a frequency band used for wireless communication. The antenna substrate 1 uses first and second frequency bands as frequency bands used for wireless communication. In the present embodiment, the first frequency band is lower than the second frequency band. The first radiation electrode 31 corresponds to the first frequency band, and the second and third radiation electrodes 32 and 33 correspond to a second frequency band different from the first frequency band. As an example, the first frequency band is a 28 GHz band (24.25 to 29.5 GHz), and the second frequency band is a 39 GHz band (37.0 to 43.5 GHz).

In order to correspond to a plurality of frequency bands, in the antenna substrate 1, a size difference between the first and second radiation electrodes 31 and 32 and a size difference between the first and third radiation electrodes 31 and 33 are larger than the size difference between the second and third radiation electrodes 32 and 33.

In the present embodiment, since the first frequency band is lower than the second frequency band, the size of first radiation electrode 31 is larger than the sizes of the second and third radiation electrodes 32 and 33. That is, the first radiation electrode 31 has a configuration appropriate for radiation of radio waves having a frequency band lower than that of the second and third radiation electrodes 32 and 33. The size difference between the first and second radiation electrodes 31 and 32 and the size difference between the first and third radiation electrodes 31 and 33 are determined such that the first radiation electrode 31 corresponds to the first frequency band but does not correspond to the second frequency band. How much the size difference is allowed is determined by a difference between the first and second frequency bands.

The size difference between the second and third radiation electrodes 32 and 33 is set such that the second and third radiation electrodes 32 and 33 correspond to the same second frequency band. That is, the size difference between the second and third radiation electrodes 32 and 33 is only required to be set such that a frequency corresponding to the size of the second radiation electrode 32 and a frequency corresponding to the size of the third radiation electrode 33 are included in the second frequency band. For example, even when the frequency corresponding to the size of the second radiation electrode 32 is set to 37.0 GHz and the frequency corresponding to the size of the third radiation electrode 33 is set to 43.5 GHz, both these frequencies are included in the second frequency band (37.0 to 43.5 GHz). Therefore, it can be said that the size difference between the second and third radiation electrodes 32 and 33 is set such that the second and third radiation electrodes 32 and 33 correspond to the same second frequency band. Of course, the size difference between the second and third radiation electrodes 32 and 33 may be 0, in other words, the size of the second radiation electrode 32 may be equal to the size of the third radiation electrode 33.

In FIG. 2, the size of the first radiation electrode 31 is larger than the size of the second radiation electrode 32 and the size of the third radiation electrode 33, and the size of the second radiation electrode 32 is equal to the size of the third radiation electrode 33. This configuration enables improvement in antenna characteristics.

In the present embodiment, the first radiation electrode 31 includes the first and second sides 31a and 31b facing each other in the direction of the first linear line L1, and third and fourth sides 31c and 31d facing each other in the direction of second linear line L2. The second radiation electrode 32 includes the first and second sides 32a and 32b facing each other in the direction of the first linear line L1, and the third and fourth sides 32c and 32d facing each other in the direction of the second linear line L2. The third radiation electrode 33 includes first and second sides 33a and 33b facing each other in the direction of the first linear line L1, and the third and fourth sides 33c and 33d facing each other in the direction of the second linear line L2.

The size of the first radiation electrode 31 may be defined by any value of 1 or more based on a distance between two intersections of a linear line passing the center of the first radiation electrode 31 and the outer periphery of the first radiation electrode 31. For example, when the first radiation electrode 31 has a square shape, a size of the first radiation electrode 31 may be defined by a distance between two opposing sides. For example, when the first radiation electrode 31 has a rectangular shape, a size of the first radiation electrode 31 may be defined by a length of a diagonal line, or may be defined by a distance between short sides and a distance between long sides. For example, when the first radiation electrode 31 has a circular shape, the size of the first radiation electrode 31 may be defined by a diameter. For example, when the first radiation electrode 31 has an elliptical shape, the size of the first radiation electrode 31 may be defined by the major and minor axes. The same applies to the second and third radiation electrodes 32 and 33. Any one or more values based on a distance between two intersections may be representative values such as an average value, a mode value, a maximum value, a minimum value, a median value, and a mode value of the distance between two intersections.

In the present embodiment, the size of the first radiation electrode 31 is defined by a distance between the first and second sides 31a and 31b or a distance between the third and fourth sides 31c and 31d. The size of the second radiation electrode 32 is defined by a distance between the first and second sides 32a and 32b or a distance between the third and fourth sides 32c and 32d. The size of the third radiation electrode 33 is defined by a distance between the first and second sides 33a and 33b or a distance between the third and fourth sides 33c and 33d.

In the present embodiment, the first to third radiation electrodes 31 to 33 are square and similar as viewed in the thickness direction of the dielectric substrate 2. When the first to third radiation electrodes 31 to 33 have similar shapes, the size difference between the first to third radiation electrodes 31 to 33 can also be determined by a similarity ratio.

The grounding electrode 5 is located on the side opposite to the main surface 2a in the dielectric substrate 2. The grounding electrode 5 is located on the back surface 2b of the dielectric substrate 2. The grounding electrode 5 forms each patch antenna together with the first to third radiation electrodes 31 to 33.

The processing circuit 6 is mounted on the main surface 2a of the dielectric substrate 2 and connected to the first and second feed lines 41 and 42. The processing circuit 6 includes, for example, an IC. Examples of the processing circuit 6 include a system in package (SiP). The processing circuit 6 performs a process of performing wireless communication using the first to third radiation electrodes 31 to 33.

In the present embodiment, the processing circuit 6 uses the first to third radiation electrodes 31 to 33 as a dual-polarized antenna corresponding to a plurality of frequency bands. The processing circuit 6 outputs a first signal S1 to the first feed line 41 and outputs a second signal S2 to the second feed line 42. The first and second signals S1 and S2 are signals with the same frequency band. However, the first and second signals S1 and S2 have different polarizations. For example, the first signal S1 is a horizontally polarized (H-polarized) signal, and the second signal S2 is a vertically polarized (V-polarized) signal. The frequency bands of the first and second signals S1 and S2 are selected from a first frequency band corresponding to the first radiation electrode 31 and a second frequency band corresponding to the second and third radiation electrodes 32 and 33.

Next, an operation of the antenna substrate 1 will be described briefly. The processing circuit 6 outputs the horizontally polarized (H-polarized) first signal S1 to the first feed line 41 and outputs the vertically polarized (V-polarized) second signal S2 to the second feed line 42.

It is assumed that the first and second signals S1 and S2 are signals with a first frequency band. In this case, the first signal S1 reaches the first radiation electrode 31 through first feed line 41, and is radiated as a horizontally polarized radio wave by the first radiation electrode 31. The second signal S2 reaches the first radiation electrode 31 through the second feed line 42, and is radiated as a vertically polarized radio wave by the first radiation electrode 31. In this way, the first radiation electrode 31 alone functions as a dual-polarized antenna.

It is assumed that the first and second signals S1 and S2 are signals with the second frequency band. In this case, the first signal S1 reaches the first radiation electrode 31 through the first feed line 41, further passes through the first radiation electrode 31, reaches the third radiation electrode 33 through the fourth feed line 44, and is radiated as a horizontally polarized radio wave by the third radiation electrode 33. The second signal S2 reaches the first radiation electrode 31 through the second feed line 42, further passes through the first radiation electrode 31, reaches the second radiation electrode 32 through the third feed line 43, and is radiated as a vertically polarized radio wave by the second radiation electrode 32. Thus, a set of second and third radiation electrodes 32 and 33 functions as a dual-polarized antenna.

In the antenna substrate 1, the first radiation electrode 31 alone can function as a dual-polarized antenna corresponding to the first frequency band. Therefore, as the dual-polarized antenna corresponding to the first frequency band, only a single radiation electrode may be disposed instead of the plurality of radiation electrodes. Therefore, an area required for arranging the radiation electrodes can be reduced.

### 1.1.2 Effects and Like

The antenna substrate 1 described above includes the dielectric substrate 2 having the main surface 2a, and the first to third planar radiation electrodes 31 to 33 and the first and second feed lines 41 and 42 on the main surface 2a of the dielectric substrate 2. The size difference between the first and second radiation electrodes 31 and 32 and the size difference between the first and third radiation electrodes 31 and 33 are larger than the size difference between the second and third radiation electrodes 32 and 33. The first and second feed lines 41 and 42 are connected to the first radiation electrode 31 at different first and second connection points P1 and P2, respectively. The first radiation electrode 31 is adjacent to the second radiation electrode 32 in the first direction intersecting the direction of the first linear line L1 connecting the first connection point P1 to the center C1 of the first radiation electrode 31 within the main surface 2a, intersects the direction of the second linear line L2 connecting the second connection point P2 to the center C1 of the first radiation electrode 31 within the main surface 2a, and is adjacent to the third radiation electrode 33 in the second direction different from the first direction. This configuration can be applied to a dual-polarized antenna corresponding to a plurality of frequency bands, and can reduce the area required for disposing the radiation electrodes. Further, this configuration enables improvement in symmetry of arrangement of the first to third planar radiation electrodes 31 to 33.

In the antenna substrate 1, the first and second feed lines 41 and 42 transmit the signals S1 and S2 with the same frequency band. This configuration can be applied to a dual-polarized antenna corresponding to a plurality of frequency bands, and can reduce the area required for disposing the radiation electrodes.

The antenna substrate 1 further includes the third feed line 43 connecting the first radiation electrode 31 to the second radiation electrode 32, and the fourth feed line 44 connecting the first radiation electrode 31 to the third radiation electrode 33. In this configuration, it is possible to widen frequency bands of the second and third radiation electrodes 32 and 33 as compared with a case where electromagnetic field coupling is provided between the first and second radiation electrodes 31 and 32 and between the first and third radiation electrodes 31 and 33. In this configuration, an amount of power supplied to the second and third radiation electrodes 32 and 33 is improved, and the antenna gain can be improved, as compared with a case where electromagnetic field coupling is provided between the first and second radiation electrodes 31 and 32 and between the first and third radiation electrodes 31 and 33.

In the antenna substrate 1, the size of the first radiation electrode 31 is larger than the sizes of the second and third radiation electrodes 32 and 33. In this configuration, the first radiation electrode 31 can be appropriate for radiation of radio waves having a frequency band lower than that of the second and third radiation electrodes 32 and 33.

In the antenna substrate 1, each of the first to third radiation electrodes 31 to 33 includes the first and second sides 31a to 33a and 31b to 33b facing each other in the direction of first linear line L1, and the third and fourth sides 31c to 33c and 31d to 33d facing each other in the direction of the second linear line L2. The size of each of the first to third radiation electrodes 31 to 33 is defined by the distance between the first and second sides 31a to 33a and 31b to 33b and the distance between the third and fourth sides 31c to 33c and 31d to 33d. This configuration can be applied to a dual-polarized antenna corresponding to a plurality of frequency bands, and can reduce the area required for disposing the radiation electrodes.

In the antenna substrate 1, the first to third radiation electrodes 31 to 33 are similar to each other when viewed in the thickness direction of the dielectric substrate 2. The size difference between the first to third radiation electrodes 31 to 33 is determined by a similarity ratio. This configuration can be applied to a dual-polarized antenna corresponding to a plurality of frequency bands, and can reduce the area required for disposing the radiation electrodes.

In the antenna substrate 1, the size of the second radiation electrode 32 is equal to the size of the third radiation electrode 33. This configuration enables improvement in antenna characteristics.

In the antenna substrate 1, the first and second linear lines L1 and L2 are orthogonal to each other. This configuration enables improvement in antenna characteristics.

The antenna substrate 1 further includes the grounding electrode 5 on the opposite side of the dielectric substrate 2 from the main surface 2a. This configuration can be applied to a dual-polarized antenna corresponding to a plurality of frequency bands, and can reduce the area required for disposing the radiation electrodes.

### 1.2 Second Embodiment

### 1.2.1 Configuration

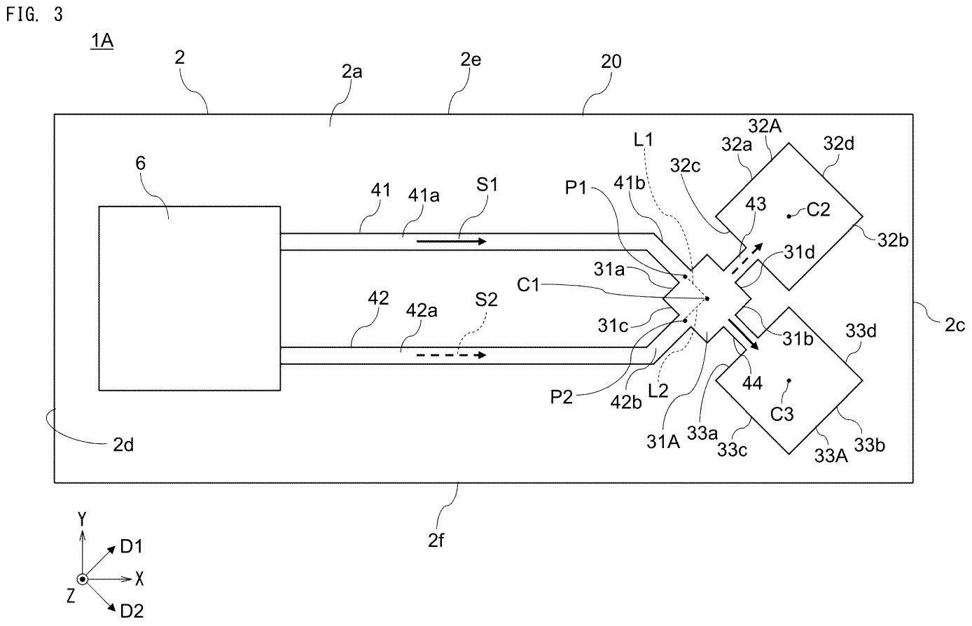

FIG. 3 is a plan view of an antenna substrate 1A according to a second embodiment. The antenna substrate 1A includes the dielectric substrate 2, a first radiation electrode 31A, a second radiation electrode 32A, a third radiation electrode 33A, the first feed line 41, the second feed line 42, the third feed line 43, the fourth feed line 44, the grounding electrode 5, and the processing circuit 6.

Similarly to the first to third radiation electrodes 31 to 33, the first to third radiation electrodes 31A to 33A are arranged such that the first radiation electrode 31A is adjacent to the second radiation electrode 32A in the first direction D1 intersecting the direction of the first linear line L1 within the main surface 2a, intersects the direction of the second linear line L2 within the main surface 2a, and is adjacent to the third radiation electrode 33A in the second direction D2 different from the first direction D1.

The first to third radiation electrodes 31A to 33A have the same shape as the first to third radiation electrodes 31 to 33, and the size difference between the first and second radiation electrodes 31A and 32A and the size difference between the first and third radiation electrodes 31A and 33A are larger than the size difference between the second and third radiation electrodes 32A and 33A.

The first radiation electrode 31A corresponds to a first frequency band, and the second and third radiation electrodes 32A and 33A correspond to a second frequency band different from the first frequency band. In the present embodiment, the first frequency band is higher than the second frequency band. As an example, the first frequency band is a 39 GHz band (37.0 to 43.5 GHz), and the second frequency band is a 28 GHz band (24.25 to 29.5 GHz).

Therefore, the size of the first radiation electrode 31A is smaller than the sizes of the second and third radiation electrodes 32A and 33A. That is, the first radiation electrode 31A has a configuration appropriate for radiation of radio waves having a frequency band higher than that of the second and third radiation electrodes 32A and 33A. In FIG. 3, the size of the first radiation electrode 31A is smaller than the sizes of the second and third radiation electrodes 32A and 33A, and the size of the second radiation electrode 32A is equal to the size of the third radiation electrode 33A. This configuration enables improvement in antenna characteristics.

### 1.2.2 Effects and Like

The antenna substrate 1A described above includes the dielectric substrate 2 having the main surface 2a, and the first to third planar radiation electrodes 31A to 33A and the first and second feed lines 41 and 42 on the main surface 2a of the dielectric substrate 2. The size difference between the first and second radiation electrodes 31A and 32A and the size difference between the first and third radiation electrodes 31A and 33A are larger than the size difference between the second and third radiation electrodes 32A and 33A. The first and second feed lines 41 and 42 are connected to the first radiation electrode 31A at different first and second connection points P1 and P2, respectively. The first radiation electrode 31A is adjacent to the second radiation electrode 32A in the first direction intersecting the direction of the first linear line L1 connecting the first connection point P1 to the center C1 of the first radiation electrode 31 within the main surface 2a, intersects the direction of the second linear line L2 connecting the second connection point P2 to the center C1 of the first radiation electrode 31A within the main surface 2a, and is adjacent to the third radiation electrode 33A in the second direction different from the first direction. This configuration can be applied to a dual-polarized antenna corresponding to a plurality of frequency bands, and can reduce the area required for disposing the radiation electrodes.

In the antenna substrate 1A, the size of the first radiation electrode 31A is smaller than the sizes of the second and third radiation electrodes 32A and 33A. In this configuration, the first radiation electrode 31A can be appropriate for radiation of radio waves having a higher frequency band than the second and third radiation electrodes 32A and 33A.

### 1.3 Third Embodiment

### 1.3.1 Configuration

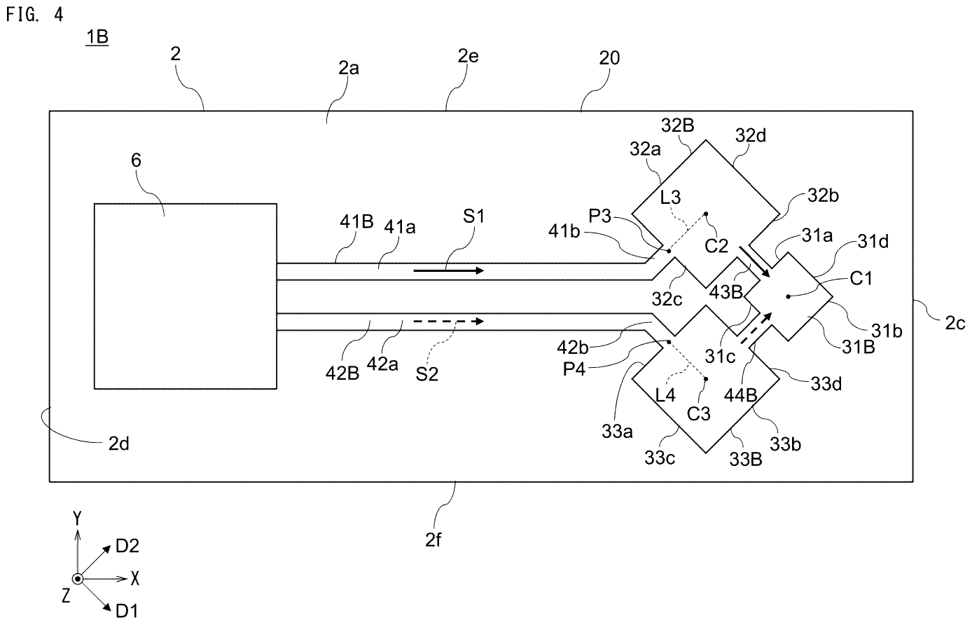

FIG. 4 is a plan view of an antenna substrate 1B according to a third embodiment. The antenna substrate 1B includes the dielectric substrate 2, a first radiation electrode 31B, a second radiation electrode 32B, a third radiation electrode 33B, a first feed line 41B, a second feed line 42B, a third feed line 43B, a fourth feed line 44B, the grounding electrode 5, and the processing circuit 6.

In the present embodiment, the first radiation electrode 31B is located on a side opposite to the processing circuit 6 with respect to the second and third radiation electrodes 32B and 33B. The first and second feed lines 41B and 42B are connected to the second and third radiation electrodes 32B and 33B, respectively, instead of the first radiation electrode 31B In the second radiation electrode 32B, the first and third sides 32a and 32c face the processing circuit 6 side, and a first connection point P3 with the first feed line 41B is set on the third side 32c. The first connection point P3 is a virtual point. The first connection point P3 is, for example, a midpoint of the third side 32c.

In the third radiation electrode 33B, the first and third sides 33a and 33c face the processing circuit 6, and a second connection point P4 with the second feed line 42B is set on the first side 33a. The second connection point P4 is a virtual point. The second connection point P4 is, for example, a midpoint of the first side 33a.

The first feed line 41B is connected to the second radiation electrode 32B at the first connection point P3. The first feed line 41B connects the processing circuit 6 to the second radiation electrode 32B. The first feed line 41B includes the first and second portions 41a and 41b. The first portion 41a extends in the X direction from the processing circuit 6 to the second radiation electrode 32B. The first portion 41a is not arranged with the first connection point P3 of the second radiation electrode 32B in the Y direction, and is located on the second connection point P4 side with respect to the first connection point P3. The second portion 41b extends from an end of the first portion 41a on the second radiation electrode 32B side to the third side 32c of the second radiation electrode 32B, and is connected to the first connection point P3. The direction in which the second portion 41b extends matches the direction of the first linear line L3 connecting the first connection point P3 to the center C2 of the second radiation electrode 32B. The first linear line L3 is a virtual line.

The second feed line 42B is connected to the third radiation electrode 33B at the second connection point P4. The second feed line 42B connects the processing circuit 6 to the third radiation electrode 33B. The second feed line 42B includes first and second portions 42a and 42b. The first portion 42a extends in the X direction from the processing circuit 6 to the third radiation electrode 33B. The first portion 42a is not arranged with the second connection point P4 of the third radiation electrode 33B in the Y direction, and is located on the first connection point P3 side with respect to the second connection point P4. The second portion 42b extends from the end of the first portion 42a on the third radiation electrode 33B side to the first side 33a of the third radiation electrode 33B, and is connected to the second connection point P4. The direction in which the second portion 42b extends matches the direction of the second linear line L4 connecting the second connection point P4 to the center C3 of the third radiation electrode 33B. The second linear line L4 is a virtual line. In the present embodiment, the second linear line L4 is orthogonal to the first linear line L3 within the main surface 2a.

The first radiation electrode 31B is adjacent to the second radiation electrode 32B in the first direction D1 intersecting the direction of the first linear line L3 within the main surface 2a. In the present embodiment, the first direction D1 is orthogonal to the direction of the first linear line L3 within the main surface 2a. Therefore, the first direction D1 and the direction of the second linear line L2 match each other. The first radiation electrode 31B is adjacent to the third radiation electrode 33B in the second direction D2 intersecting the direction of the second linear line L4 within the main surface 2a. In the present embodiment, the second direction D2 is orthogonal to the direction of the second linear line L4 within the main surface 2a. Therefore, the second direction D2 matches the direction of the first linear line L3.

The first side 31a of the first radiation electrode 31B faces the second side 32b of the second radiation electrode 32B with a predetermined distance therebetween. The first side 31a of the first radiation electrode 31B and the second side 32b of the second radiation electrode 32B are parallel to each other. The third side 31c of the first radiation electrode 31B faces the fourth side 33d of the third radiation electrode 33B with a predetermined distance therebetween. The third side 31c of the first radiation electrode 31B and the fourth side 33d of the third radiation electrode 33B are parallel to each other.

The third feed line 43B connects the first radiation electrode 31B to the second radiation electrode 32B. Accordingly, the first and second radiation electrodes 31B and 32B are directly connected to each other, and a signal propagates from the first radiation electrode 31B to the second radiation electrode 32B. In the present embodiment, the third feed line 43B extends in the first direction D1.

The fourth feed line 44B connects the first to third radiation electrodes 31B to 33B. Accordingly, the first and third radiation electrodes 31B and 33B are directly connected to each other, and a signal propagates from the first radiation electrode 31B to the third radiation electrode 33B. In the present embodiment, the fourth feed line 44B extends in the second direction D2.

As described above, the first to third radiation electrodes 31B to 33B are arranged such that the first radiation electrode 31B is adjacent to the second radiation electrode 32B in the first direction D1 intersecting the direction of the first linear line L3 within the main surface 2a, intersects the direction of the second linear line L4 within the main surface 2a, and is adjacent to the third radiation electrode 33B in the second direction D2 different from the first direction D1.

In the antenna substrate 1B, the first radiation electrode 31B, the second radiation electrode 32B, and the third radiation electrode 33B form a dual-polarized antenna corresponding to a plurality of frequency bands. In the present embodiment, as in the second embodiment, the first frequency band is higher than the second frequency band, the size of the first radiation electrode 31B is smaller than the sizes of the second and third radiation electrodes 32B and 33B, and the size of the second radiation electrode 32B is equal to a size of the third radiation electrode 33B.

Next, an operation of the antenna substrate 1B will be described briefly. The processing circuit 6 outputs a horizontally polarized (H-polarized) first signal S1 to the first feed line 41B and outputs a vertically polarized (V-polarized) second signal S2 to the second feed line 42B.

It is assumed that the first and second signals S1 and S2 are signals with the first frequency band. In this case, the first signal S1 passes through the first feed line 41B and reaches the second radiation electrode 32B, further passes through the second radiation electrode 32B, passes through third feed line 43B and reaches first radiation electrode 31B, and is radiated as a horizontally polarized radio wave by the first radiation electrode 31B. The second signal S2 reaches the third radiation electrode 33B through the second feed line 42B, further passes through the third radiation electrode 33B, reaches the first radiation electrode 31B through the fourth feed line 44B, and is radiated as a vertically polarized radio wave by the first radiation electrode 31B. In this way, the first radiation electrode 31B alone functions as a dual-polarized antenna.

It is assumed that the first and second signals S1 and S2 are signals with the second frequency band. In this case, the first signal S1 reaches the second radiation electrode 32B through the first feed line 41B, and is radiated as a horizontally polarized radio wave by the second radiation electrode 32B. The second signal S2 reaches the third radiation electrode 33B through the second feed line 42B, and is radiated as a vertically polarized radio wave by the third radiation electrode 33B. Thus, a set of second and third radiation electrodes 32B and 33B functions as a dual-polarized antenna.

In the antenna substrate 1B, the first radiation electrode 31B alone can function as a dual-polarized antenna corresponding to the first frequency band. Therefore, as the dual-polarized antenna corresponding to the first frequency band, only a single radiation electrode may be disposed instead of the plurality of radiation electrodes. Therefore, an area required for arranging the radiation electrodes can be reduced.

### 1.3.2 Effects and Like

The antenna substrate 1B described above includes the dielectric substrate 2 having the main surface 2a, and the first to third planar radiation electrodes 31B to 33B and the first and second feed lines 41B and 42B on the main surface 2a of the dielectric substrate 2. The size difference between the first and second radiation electrodes 31B and 32B and the size difference between the first and third radiation electrodes 31B and 33B are larger than the size difference between the second and third radiation electrodes 32B and 33B. The first feed line 41B is connected to the second radiation electrode 32B at the first connection point P3. The second feed line 42B is connected to the third radiation electrode 33B at the second connection point P4. The first radiation electrode 31B is adjacent to the second radiation electrode 32B in the first direction D1 intersecting the first linear line L3 connecting the first connection point P3 to the center C2 of the second radiation electrode 32B within the main surface 2a, intersects the second linear line L4 connecting the second connection point P4 to the center C3 of the third radiation electrode 33B within the main surface 2a, and is adjacent to the third radiation electrode 33B in the second direction D2 different from the first direction D1. This configuration can be applied to a dual-polarized antenna corresponding to a plurality of frequency bands, and can reduce the area required for disposing the radiation electrodes. Further, this configuration enables improvement in symmetry of arrangement of the first to third planar radiation electrodes 31 to 33.

In the antenna substrate 1B, the size of the first radiation electrode 31B is smaller than the sizes of the second and third radiation electrodes 32B and 33B. In this configuration, the first radiation electrode 31B can be appropriate for radiation of radio waves having a higher frequency band than the second and third radiation electrodes 32B and 33B.

### 1.4 Fourth Embodiment

### 1.4.1 Configuration

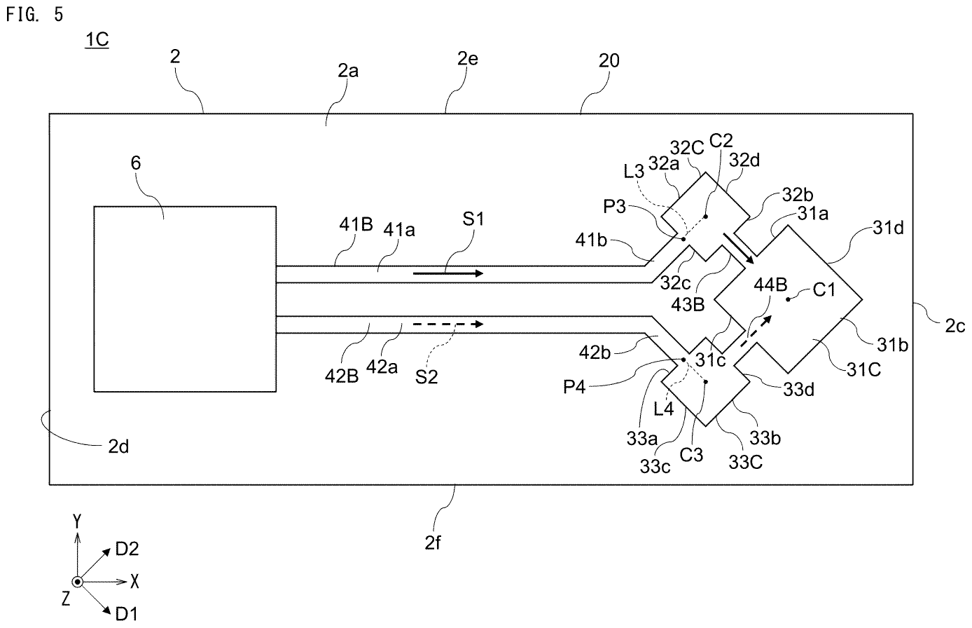

FIG. 5 is a plan view of an antenna substrate 1C according to a fourth embodiment. The antenna substrate 1C includes the dielectric substrate 2, a first radiation electrode 31C, a second radiation electrode 32C, a third radiation electrode 33C, the first feed line 41B, the second feed line 42B, the third feed line 43, the fourth feed line 44, the grounding electrode 5, and the processing circuit 6.

Similarly to the first to third radiation electrodes 31B to 33B, the first to third radiation electrodes 31C to 33C are arranged such that the first radiation electrode 31C is adjacent to the second radiation electrode 32C in the first direction D1 intersecting the direction of the first linear line L3 within the main surface 2a, intersects the direction of the second linear line L4 within the main surface 2a, and is adjacent to the third radiation electrode 33C in the second direction D2 different from the first direction D1.

The first to third radiation electrodes 31C to 33C have the same shape as the first to third radiation electrodes 31B to 33B, and the size difference between the first and second radiation electrodes 31C and 32C and the size difference between the first and third radiation electrodes 31C and 33C are larger than the size difference between the second and third radiation electrodes 32C and 33C.

The first radiation electrode 31C corresponds to the first frequency band, and the second and third radiation electrodes 32C and 33C correspond to the second frequency band different from the first frequency band. In the present embodiment, the first frequency band is lower than the second frequency band. As an example, the first frequency band is a 28 GHz band (24.25 to 29.5 GHz), and the second frequency band is a 39 GHz band (37.0 to 43.5 GHz).

Therefore, the size of the first radiation electrode 31C is larger than the sizes of the second and third radiation electrodes 32C and 33C. That is, the first radiation electrode 31C has a configuration appropriate for radiation of radio waves having a frequency band lower than that of the second and third radiation electrodes 32C and 33C. In FIG. 5, the size of the first radiation electrode 31C is larger than the sizes of the second and third radiation electrodes 32C and 33C, and the size of the second radiation electrode 32C is equal to the size of the third radiation electrode 33C. This configuration enables improvement in antenna characteristics.

### 1.4.2 Effects and Like

The antenna substrate 1C described above includes the dielectric substrate 2 having the main surface 2a, and the first to third planar radiation electrodes 31C to 33C and the first and second feed lines 41B and 42B on the main surface 2a of the dielectric substrate 2. The size difference between the first and second radiation electrodes 31C and 32C and the size difference between the first and third radiation electrodes 31C and 33C are larger than the size difference between the second and third radiation electrodes 32C and 33C. The first feed line 41B is connected to the second radiation electrode 32C at the first connection point P3. The second feed line 42B is connected to the third radiation electrode 33C at the second connection point P4. The first radiation electrode 31C is adjacent to the second radiation electrode 32C in the first direction D1 intersecting the first linear line L3 connecting the first connection point P3 to the center C2 of the second radiation electrode 32C within the main surface 2a, intersects the second linear line L4 connecting the second connection point P4 to the center C3 of the third radiation electrode 33C within the main surface 2a, and is adjacent to the third radiation electrode 33C in the second direction D2 different from the first direction D1. This configuration can be applied to a dual-polarized antenna corresponding to a plurality of frequency bands, and can reduce the area required for disposing the radiation electrodes.

In the antenna substrate 1C, the size of the first radiation electrode 31C is larger than the sizes of the second and third radiation electrodes 32C and 33C. In this configuration, the first radiation electrode 31C can be configured to be appropriate for radiation of radio waves having a frequency band lower than that of the second and third radiation electrodes 32C and 33C.

### 1.5 Fifth Embodiment

### 1.5.1 Configuration

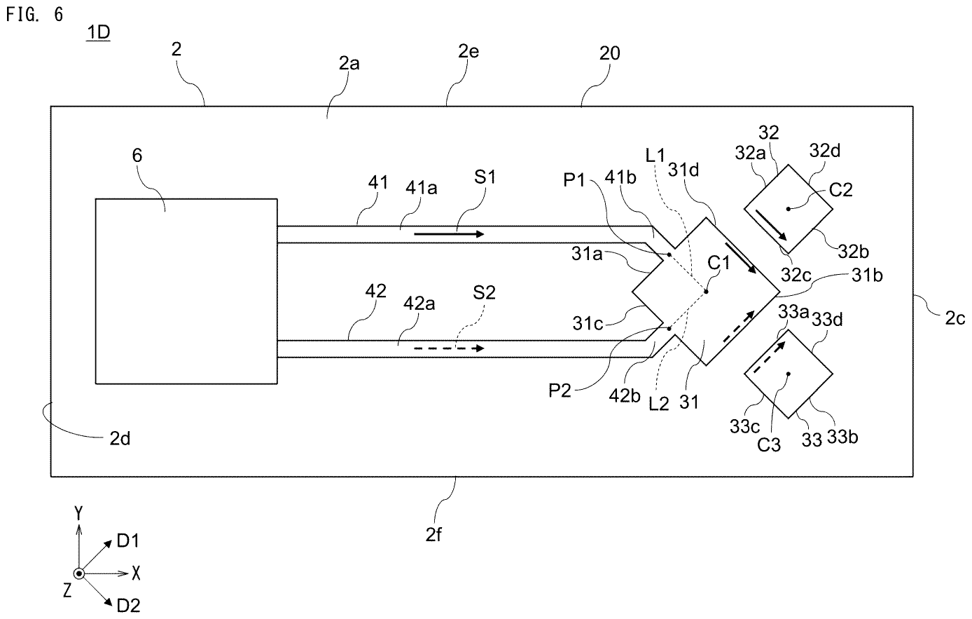

FIG. 6 is a plan view of an antenna substrate 1D according to a fifth embodiment. Similarly to the antenna substrate 1, the antenna substrate 1D includes the dielectric substrate 2, the first radiation electrode 31, the second radiation electrode 32, the third radiation electrode 33, the first feed line 41, the second feed line 42, the grounding electrode 5, and the processing circuit 6.

Unlike the antenna substrate 1, the antenna substrate 1D does not include the third and fourth feed lines 43 and 44. Accordingly, in the antenna substrate 1D, the first radiation electrode 31 is not directly connected to either the second or third radiation electrode 32 or 33.

A distance between the first and second radiation electrodes 31 and 32 is less than any of the sizes of the first and second radiation electrodes 31 and 32 in the first direction D1. The distance between the first and second radiation electrodes 31 and 32 is a distance between the fourth side 31d of the first radiation electrode 31 and the third side 32c of the second radiation electrode 32. The size of the first radiation electrode 31 in the first direction D1 is a distance between the third and fourth sides 31c and 31d, and the size of the second radiation electrode 32 in the first direction D1 is a distance between the third and fourth sides 31c and 31d. This configuration enables electromagnetic field coupling, that is, capacitive coupling, between the first radiation electrode 31 and the second radiation electrode 32. Therefore, when a current flows along the fourth side 31d of the first radiation electrode 31, the current can flow in the same direction along the third side 32c of the second radiation electrode 32.

The distance between the first and third radiation electrodes 31 and 33 is smaller than any of the sizes of the first and third radiation electrodes 31 and 33 in the second direction D2. The distance between the first and third radiation electrodes 31 and 33 is the distance between the second side 31b of the first radiation electrode 31 and the first side 33a of the third radiation electrode 33. The size of the first radiation electrode 31 in the second direction D2 is a distance between the first and second sides 31a and 31b, and the size of the third radiation electrode 33 in the second direction D2 is a distance between the first and second sides 33a and 33b. This configuration enables electromagnetic field coupling, that is, capacitive coupling, between the first and third radiation electrodes 31 and 33. Therefore, when a current flows along the second side 31b of the first radiation electrode 31, the current can flow in the same direction along the first side 33a of the third radiation electrode 33.

The size of the first radiation electrode 31 is larger than the sizes of the second and third radiation electrodes 32 and 33. That is, the first radiation electrode 31 has a configuration appropriate for radiation of radio waves having a frequency band higher than that of the second and third radiation electrodes 32 and 33. In FIG. 6, the size of the first radiation electrode 31 is larger than the sizes of the second and third radiation electrodes 32 and 33, and the size of the second radiation electrode 32 is equal to the size of the third radiation electrode 33. This configuration enables improvement in antenna characteristics.

Because the size of the first radiation electrode 31 is larger than the size of the second radiation electrode 32, the fourth side 31d of the first radiation electrode 31 facing the second radiation electrode 32 is longer than the third side 32c of the second radiation electrode 32 facing the first radiation electrode 31. This can improve an amount of power supplied from the first radiation electrode 31 to the second radiation electrode 32, and can improve antenna efficiency in the second radiation electrode 32.

Since the size of the first radiation electrode 31 is larger than the size of the third radiation electrode 33, the second side 31b of the first radiation electrode 31 facing the third radiation electrode 33 is longer than the first side 33a of the third radiation electrode 33 facing the first radiation electrode 31. This makes it possible to improve an amount of power supplied from the first radiation electrode 31 to the third radiation electrode 33 and improve antenna efficiency in the third radiation electrode 33.

Next, an operation of the antenna substrate 1D will be described briefly. The processing circuit 6 outputs the horizontally polarized (H-polarized) first signal S1 to the first feed line 41 and outputs the vertically polarized (V-polarized) second signal S2 to the second feed line 42.

It is assumed that the first and second signals S1 and S2 are signals with a first frequency band. In this case, the first signal S1 reaches the first radiation electrode 31 through first feed line 41, and is radiated as a horizontally polarized radio wave by the first radiation electrode 31. The second signal S2 reaches the first radiation electrode 31 through the second feed line 42, and is radiated as a vertically polarized radio wave by the first radiation electrode 31. In this way, the first radiation electrode 31 alone functions as a dual-polarized antenna.

It is assumed that the first and second signals S1 and S2 are signals with the second frequency band. In this case, the first signal S1 reaches the first radiation electrode 31 through the first feed line 41. The first signal S1 propagating along the fourth side 31d of the first radiation electrode 31 reaches the second radiation electrode 32 by electromagnetic field coupling between the first and second radiation electrodes 31 and 32, and is radiated as a horizontally polarized radio wave by the second radiation electrode 32. The second signal S2 reaches the first radiation electrode 31 through the second feed line 42. The second signal S2 propagating along the second side 31b of the first radiation electrode 31 reaches the third radiation electrode 33 by electromagnetic field coupling between the first and third radiation electrodes 31 and 33, and is radiated as a vertically polarized radio wave by the third radiation electrode 33. Thus, a set of second and third radiation electrodes 32 and 33 functions as a dual-polarized antenna.

In the antenna substrate 1D, the first radiation electrode 31 alone can function as a dual-polarized antenna corresponding to the first frequency band. Therefore, as the dual-polarized antenna corresponding to the first frequency band, only a single radiation electrode may be disposed instead of the plurality of radiation electrodes. Therefore, an area required for arranging the radiation electrodes can be reduced.

### 1.5.2 Effects and Like

The antenna substrate 1D described above includes the dielectric substrate 2 having the main surface 2a, and the first to third planar radiation electrodes 31 to 33 and the first and second feed lines 41 and 42 on the main surface 2a of the dielectric substrate 2. The size difference between the first and second radiation electrodes 31 and 32 and the size difference between the first and third radiation electrodes 31 and 33 are larger than the size difference between the second and third radiation electrodes 32 and 33. The first and second feed lines 41 and 42 are connected to the first radiation electrode 31 at different first and second connection points P1 and P2, respectively. The first radiation electrode 31 is adjacent to the second radiation electrode 32 in the first direction intersecting the direction of the first linear line L1 connecting the first connection point P1 to the center C1 of the first radiation electrode 31 within the main surface 2a, intersects the direction of the second linear line L2 connecting the second connection point P2 to the center C1 of the first radiation electrode 31 within the main surface 2a, and is adjacent to the third radiation electrode 33 in the second direction different from the first direction. This configuration can be applied to a dual-polarized antenna corresponding to a plurality of frequency bands, and can reduce the area required for disposing the radiation electrodes.

In the antenna substrate 1D, the first radiation electrode 31 is not directly connected to either the second or third radiation electrode 32 or 33. A distance between the first and second radiation electrodes 31 and 32 is less than any of the sizes of the first and second radiation electrodes 31 and 32 in the first direction D1. The distance between the first and third radiation electrodes 31 and 33 is smaller than any of the sizes of the first and third radiation electrodes 31 and 33 in the second direction D2. This configuration enables electromagnetic field coupling between the first and second radiation electrodes 31 and 32, and enables electromagnetic field coupling between the first and third radiation electrodes 31 and 33.

In the antenna substrate 1D, the size of the first radiation electrode 31 is larger than the sizes of the second and third radiation electrodes 32 and 33. In this configuration, the first radiation electrode 31 can be appropriate for radiation of radio waves having a frequency band lower than that of the second and third radiation electrodes 32 and 33. Further, an amount of power supplied from the first radiation electrode 31 to the second and third radiation electrodes 32 and 33 can be improved, and antenna efficiency in the second and third radiation electrodes 32 and 33 can be improved.

### 1.6 Sixth Embodiment

### 1.6.1 Configuration

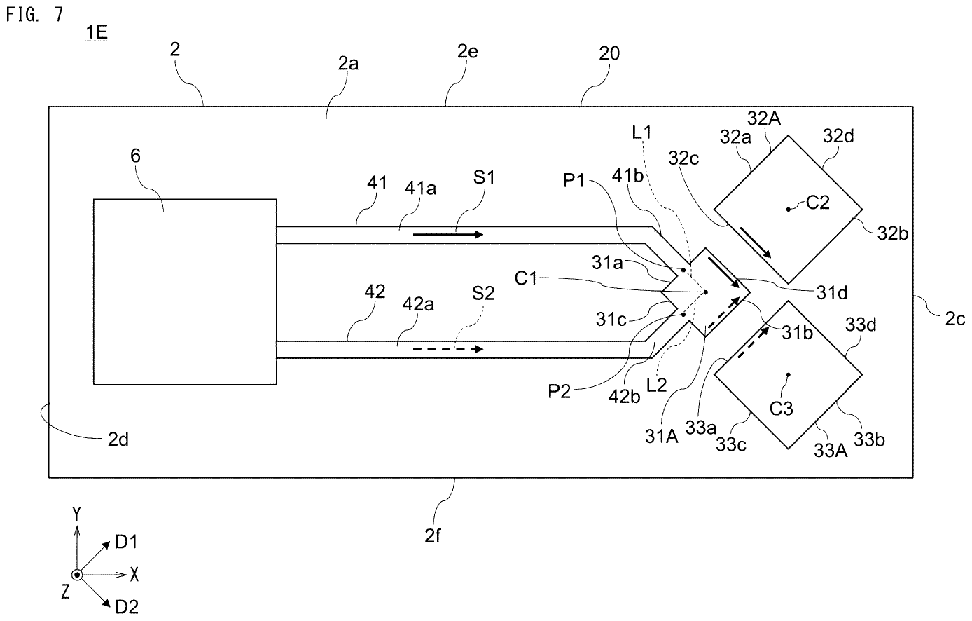

FIG. 7 is a plan view of an antenna substrate 1E according to a sixth embodiment. Similarly to the antenna substrate 1A, the antenna substrate 1E includes the dielectric substrate 2, the first radiation electrode 31A, the second radiation electrode 32A, the third radiation electrode 33A, the first feed line 41, the second feed line 42, the grounding electrode 5, and the processing circuit 6.

Unlike the antenna substrate 1A, the antenna substrate 1E does not include the third and fourth feed lines 43 and 44. Therefore, in the antenna substrate 1E, the first radiation electrode 31A is not directly connected to either the second or third radiation electrode 32A or 33A.

In the antenna substrate 1E, a distance between the first and second radiation electrodes 31A and 32A is smaller than both the sizes of the first and second radiation electrodes 31A and 32A in the first direction D1. The distance between the first and third radiation electrodes 31A and 33A is smaller than any of the sizes of the first and third radiation electrodes 31A and 33A in the second direction D2. This enables electromagnetic field coupling between the first and second radiation electrodes 31A and 32A and between the first and third radiation electrodes 31A and 33A.

The size of the first radiation electrode 31A is smaller than the sizes of the second and third radiation electrodes 32A and 33A. That is, the first radiation electrode 31A has a configuration appropriate for radiation of radio waves having a frequency band higher than that of the second and third radiation electrodes 32A and 33A. In FIG. 7, the size of the first radiation electrode 31A is smaller than the sizes of the second and third radiation electrodes 32A and 33A, and the size of the second radiation electrode 32A is equal to the size of the third radiation electrode 33A. This configuration enables improvement in antenna characteristics.

### 1.6.2 Effects and Like

The antenna substrate 1E described above includes the dielectric substrate 2 having the main surface 2a, and the first to third planar radiation electrodes 31A to 33A and the first and second feed lines 41 and 42 on the main surface 2a of the dielectric substrate 2. The size difference between the first and second radiation electrodes 31A and 32A and the size difference between the first and third radiation electrodes 31A and 33A are larger than the size difference between the second and third radiation electrodes 32A and 33A. The first and second feed lines 41 and 42 are connected to the first radiation electrode 31A at different first and second connection points P1 and P2, respectively. The first radiation electrode 31A is adjacent to the second radiation electrode 32A in the first direction intersecting the direction of the first linear line L1 connecting the first connection point P1 to the center C1 of the first radiation electrode 31A within the main surface 2a, intersects the direction of the second linear line L2 connecting the second connection point P2 to the center C1 of the first radiation electrode 31A within the main surface 2a, and is adjacent to the third radiation electrode 33A in the second direction different from the first direction. This configuration can be applied to a dual-polarized antenna corresponding to a plurality of frequency bands, and can reduce the area required for disposing the radiation electrodes.

In the antenna substrate 1E, the first radiation electrode 31A is not directly connected to either the second or third radiation electrode 32A or 33A. The distance between the first and second radiation electrodes 31A and 32A is smaller than any of the sizes of the first and second radiation electrodes 31A and 32A in the first direction D1. The distance between the first and third radiation electrodes 31A and 33A is smaller than any of the sizes of the first and third radiation electrodes 31A and 33A in the second direction D2. This configuration enables electromagnetic field coupling between the first and second radiation electrodes 31A and 32A, and enables electromagnetic field coupling between the first and third radiation electrodes 31A and 33A.

In the antenna substrate 1E, the size of the first radiation electrode 31A is smaller than the sizes of the second and third radiation electrodes 32A and 33A. In this configuration, the first radiation electrode 31A can be appropriate for radiation of radio waves having a higher frequency band than the second and third radiation electrodes 32A and 33A.

### 1.7 Seventh Embodiment

### 1.7.1 Configuration

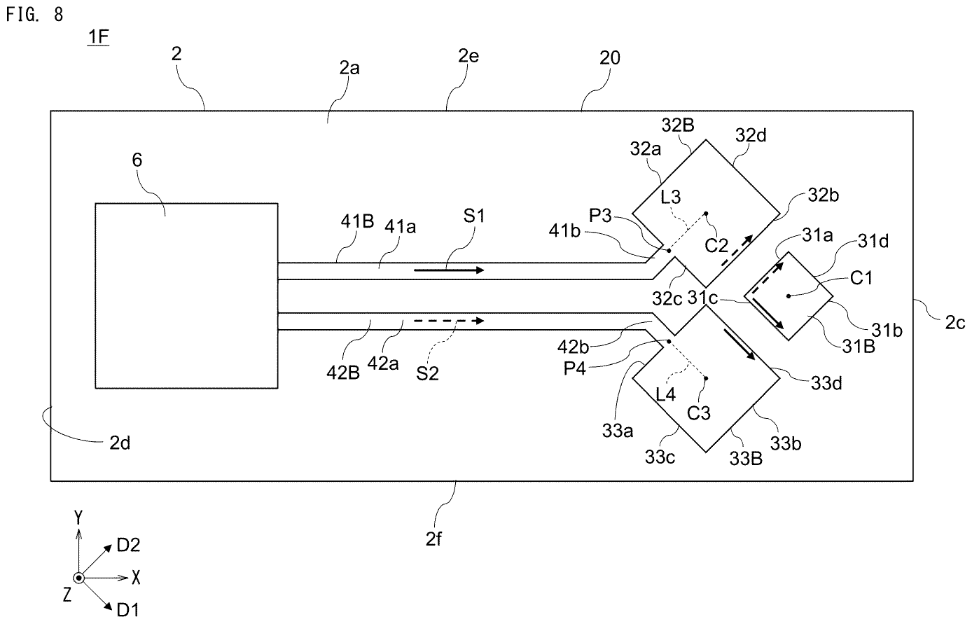

FIG. 8 is a plan view of an antenna substrate 1F according to a seventh embodiment. Similarly to the antenna substrate 1B, the antenna substrate 1F includes the dielectric substrate 2, the first radiation electrode 31B, the second radiation electrode 32B, the third radiation electrode 33B, the first feed line 41B, the second feed line 42B, the grounding electrode 5, and the processing circuit 6.

Unlike the antenna substrate 1B, the antenna substrate 1F does not include the third and fourth feed lines 43B and 44B. Therefore, in the antenna substrate 1F, the first radiation electrode 31B is not directly connected to either the second or third radiation electrode 32B or 33B.

The distance between the first and second radiation electrodes 31B and 32B is smaller than any of the sizes of the first and second radiation electrodes 31B and 32B in the first direction D1. The distance between the first and second radiation electrodes 31B and 32B is the distance between the first side 31a of the first radiation electrode 31B and the second side 32b of the second radiation electrode 32B. The size of the first radiation electrode 31B in the first direction D1 is a distance between the first and second sides 31a and 31b, and the size of the second radiation electrode 32B in the first direction D1 is a distance between the first and second sides 32a and 32b. This configuration enables electromagnetic field coupling, that is, capacitive coupling, between the first and second radiation electrodes 31B and 32B. Therefore, when a current flows along the second side 32b of the second radiation electrode 32B, the current can flow in the same direction along the first side 31a of the first radiation electrode 31B.

The distance between the first and third radiation electrodes 31B and 33B is smaller than any of the sizes of the first and third radiation electrodes 31B and 33B in the second direction D2. The distance between the first and third radiation electrodes 31B and 33B is the distance between the third side 31c of the first radiation electrode 31B and the fourth side 33d of the third radiation electrode 33B. The size of the first radiation electrode 31B in the second direction D2 is a distance between the third and fourth sides 31c and 31d, and the size of the third radiation electrode 33B in the second direction D2 is a distance between the third and fourth sides 33c and 33d. This configuration enables electromagnetic field coupling, that is, capacitive coupling, between the first radiation electrode 31B and the third radiation electrode 33B. Therefore, when a current flows along the fourth side 33d of the third radiation electrode 33B, the current can flow in the same direction along the third side 31c of the first radiation electrode 31B.

The size of the first radiation electrode 31B is smaller than the sizes of the second and third radiation electrodes 32B and 33B. That is, the first radiation electrode 31B has a configuration appropriate for radiation of radio waves having a frequency band lower than that of the second and third radiation electrodes 32B and 33B. In FIG. 8, the size of the first radiation electrode 31B is smaller than the sizes of the second and third radiation electrodes 32B and 33B, and the size of the second radiation electrode 32B is equal to the size of the third radiation electrode 33B. This configuration enables improvement in antenna characteristics.

Since the size of the first radiation electrode 31B is smaller than the size of the second radiation electrode 32B, the second side 32b of the second radiation electrode 32B facing the first radiation electrode 31B is longer than the first side 31a of the first radiation electrode 31B facing the second radiation electrode 32B. This makes it possible to improve an amount of power supplied from the second radiation electrode 32B to the first radiation electrode 31B, and antenna efficiency in the first radiation electrode 31B can be improved.

Because the size of the first radiation electrode 31B is larger than the size of the third radiation electrode 33B, the fourth side 33d of the third radiation electrode 33B facing the first radiation electrode 31B is longer than the third side 31c of the first radiation electrode 31B facing the third radiation electrode 33B. This makes it possible to improve an amount of power supplied from the third radiation electrode 33B to the first radiation electrode 31B, and antenna efficiency in the first radiation electrode 31B can be improved.

Next, an operation of the antenna substrate 1F will be described briefly. The processing circuit 6 outputs a horizontally polarized (H-polarized) first signal S1 to the first feed line 41B and outputs a vertically polarized (V-polarized) second signal S2 to the second feed line 42B.

It is assumed that the first and second signals S1 and S2 are signals with the first frequency band. In this case, the first signal S1 reaches the second radiation electrode 32B through the first feed line 41B. The first signal S1 propagating along the fourth side 31d of the second radiation electrode 32B reaches the first radiation electrode 31B by electromagnetic field coupling between the second and first radiation electrodes 32B and 31B, and is radiated as a horizontally polarized radio wave by the first radiation electrode 31B. The second signal S2 reaches the third radiation electrode 33B through the second feed line 42B. The second signal S2 propagating along the fourth side 33d of the third radiation electrode 33B reaches the first radiation electrode 31B by electromagnetic field coupling between the third and first radiation electrodes 33B and 31B, and is radiated as a vertically polarized radio wave by the first radiation electrode 31B. In this way, the first radiation electrode 31B alone functions as a dual-polarized antenna.

It is assumed that the first and second signals S1 and S2 are signals with the second frequency band. In this case, the first signal S1 reaches the second radiation electrode 32B through the first feed line 41B, and is radiated as a horizontally polarized radio wave by the second radiation electrode 32B. The second signal S2 reaches the third radiation electrode 33B through the second feed line 42B, and is radiated as a vertically polarized radio wave by the third radiation electrode 33B. Thus, a set of second and third radiation electrodes 32B and 33B functions as a dual-polarized antenna.

In the antenna substrate 1F, the first radiation electrode 31B alone can function as a dual-polarized antenna corresponding to the first frequency band. Therefore, as the dual-polarized antenna corresponding to the first frequency band, only a single radiation electrode may be disposed instead of the plurality of radiation electrodes. Therefore, an area required for arranging the radiation electrodes can be reduced.

### 1.7.2 Effects and Like

The antenna substrate 1F described above includes the dielectric substrate 2 having the main surface 2a, and the first to third planar radiation electrodes 31B to 33B and the first and second feed lines 41B and 42B on the main surface 2a of the dielectric substrate 2. The size difference between the first and second radiation electrodes 31B and 32B and the size difference between the first and third radiation electrodes 31B and 33B are larger than the size difference between the second and third radiation electrodes 32B and 33B. The first feed line 41B is connected to the second radiation electrode 32B at the first connection point P3. The second feed line 42B is connected to the third radiation electrode 33B at the second connection point P4. The first radiation electrode 31B is adjacent to the second radiation electrode 32B in the first direction D1 intersecting the first linear line L3 connecting the first connection point P3 to the center C2 of the second radiation electrode 32B within the main surface 2a, intersects the second linear line L4 connecting the second connection point P4 to the center C3 of the third radiation electrode 33B within the main surface 2a, and is adjacent to the third radiation electrode 33B in the second direction D2 different from the first direction D1. This configuration can be applied to a dual-polarized antenna corresponding to a plurality of frequency bands, and can reduce the area required for disposing the radiation electrodes.

In the antenna substrate 1F, the size of the first radiation electrode 31B is smaller than the sizes of the second and third radiation electrodes 32B and 33B. In this configuration, the first radiation electrode 31B can be appropriate for radiation of radio waves having a higher frequency band than the second and third radiation electrodes 32B and 33B. Further, an amount of power supplied from the second and third radiation electrodes 32B and 33B to the first radiation electrode 31B can be improved, and antenna efficiency in the first radiation electrode 31B can be improved.

### 1.8 Eighth Embodiment

### 1.8.1 Configuration

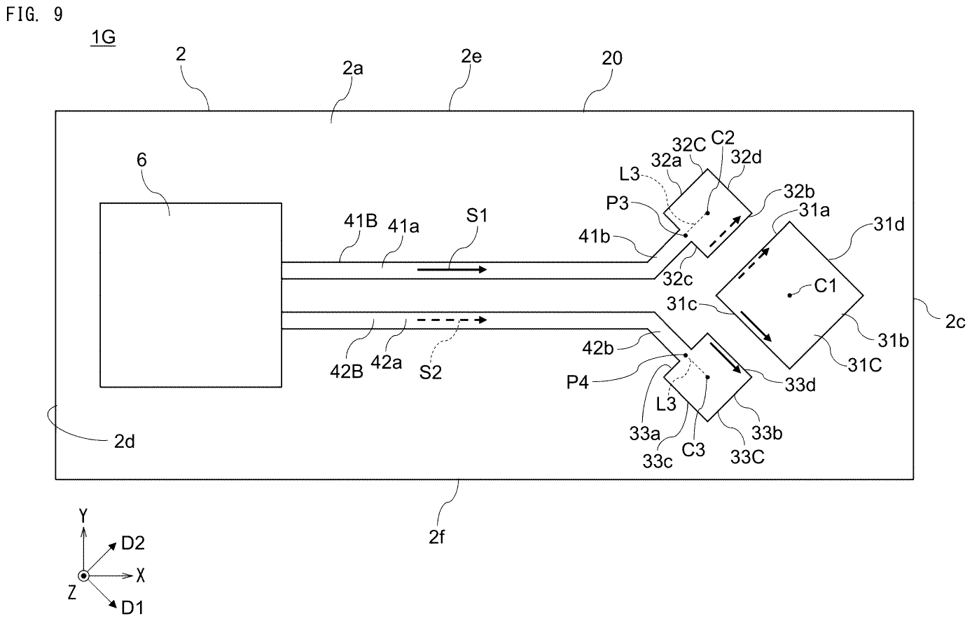

FIG. 9 is a plan view of an antenna substrate 1G according to an eighth embodiment. Similarly to the antenna substrate 1C, the antenna substrate 1G includes the dielectric substrate 2, the first radiation electrode 31C, the second radiation electrode 32C, the third radiation electrode 33C, the first feed line 41B, the second feed line 42B, the grounding electrode 5, and the processing circuit 6.

Unlike the antenna substrate 1C, the antenna substrate 1G does not include the third and fourth feed lines 43B and 44B. Therefore, in the antenna substrate 1G, the first radiation electrode 31C is not directly connected to either the second or third radiation electrode 32C or 33C.

In the antenna substrate 1C, a distance between the first and second radiation electrodes 31C and 32C is smaller than both the sizes of the first and second radiation electrodes 31C and 32C in the first direction D1. The distance between the first and third radiation electrodes 31C and 33C is smaller than any of the sizes of the first and third radiation electrodes 31C and 33C in the second direction D2. This enables electromagnetic field coupling between the first and second radiation electrodes 31C and 32C and between the first and third radiation electrodes 31C and 33C.

The size of the first radiation electrode 31C is larger than the sizes of the second and third radiation electrodes 32C and 33C. That is, the first radiation electrode 31C has a configuration appropriate for radiation of radio waves having a frequency band lower than that of the second and third radiation electrodes 32C and 33C. In FIG. 9, the size of the second radiation electrode 32C is equal to the size of the third radiation electrode 33C. This configuration enables improvement in antenna characteristics.

### 1.8.2 Effects and Like

The antenna substrate 1G described above includes the dielectric substrate 2 having the main surface 2a, and the first to third planar radiation electrodes 31C to 33C and the first and second feed lines 41B and 42B on the main surface 2a of the dielectric substrate 2. The size difference between the first and second radiation electrodes 31C and 32C and the size difference between the first and third radiation electrodes 31C and 33C are larger than the size difference between the second and third radiation electrodes 32C and 33C. The first feed line 41B is connected to the second radiation electrode 32C at the first connection point P3. The second feed line 42B is connected to the third radiation electrode 33C at the second connection point P4. The first radiation electrode 31C is adjacent to the second radiation electrode 32C in the first direction D1 intersecting the first linear line L3 connecting the first connection point P3 to the center C2 of the second radiation electrode 32C within the main surface 2a, intersects the second linear line L4 connecting the second connection point P4 to the center C3 of the third radiation electrode 33C within the main surface 2a, and is adjacent to the third radiation electrode 33C in the second direction D2 different from the first direction D1. This configuration can be applied to a dual-polarized antenna corresponding to a plurality of frequency bands, and can reduce the area required for disposing the radiation electrodes.

In the antenna substrate 1G, the size of the first radiation electrode 31C is larger than the sizes of the second and third radiation electrodes 32C and 33C. In this configuration, the first radiation electrode 31C can be configured to be appropriate for radiation of radio waves having a frequency band lower than that of the second and third radiation electrodes 32C and 33C.

### 1.9 Ninth Embodiment

### 1.9.1 Configuration

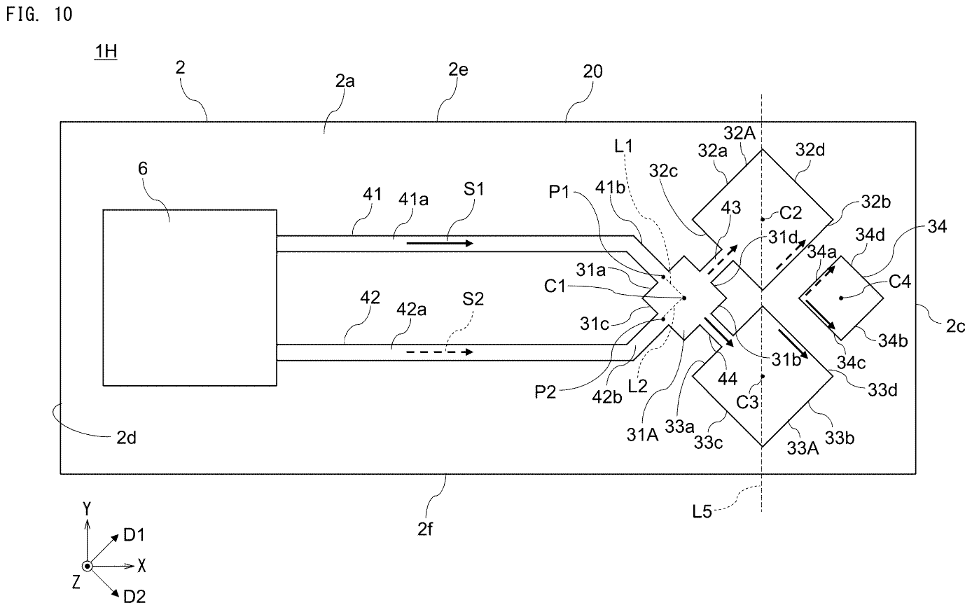

FIG. 10 is a plan view of an antenna substrate 1H according to a ninth embodiment. Similarly to the antenna substrate 1A, the antenna substrate 1H includes the dielectric substrate 2, the first radiation electrode 31A, the second radiation electrode 32A, the third radiation electrode 33A, the first feed line 41, the second feed line 42, the grounding electrode 5, and the processing circuit 6. The antenna substrate 1H further includes a fourth radiation electrode 34.

The fourth radiation electrode 34 has a planar shape. The fourth radiation electrode 34 has first and second sides 34a and 34b facing each other, and third and fourth sides 34c and 34d facing each other. When viewed in the thickness direction of the dielectric substrate 2, the fourth radiation electrode 34 has a quadrilateral shape formed by the first to fourth sides 34a to 34d. In the present embodiment, the lengths of the first to fourth sides 34a to 34d are equal to each other, and the fourth radiation electrode 34 has a square shape when viewed in the thickness direction of the dielectric substrate 2.

The first and third sides 34a and 34c face the second end 2d, and the second and fourth sides 34b and 34d face the first end 2c. The first and fourth sides 34a and 34d face the third end 2e, and the second and third sides 34b and 34c face the fourth end 2f. In the present embodiment, a diagonal line between a vertex between the first and third sides 34a and 34c and a vertex between the second and fourth sides 34b and 34d is along the X direction, and a diagonal line between a vertex between the first and fourth sides 34a and 34d and a vertex between the second and third sides 34b and 34c is along the Y direction.

The fourth radiation electrode 34 is located on the opposite side to the first radiation electrode 31A with respect to the third linear line L5 connecting the center C2 of the second radiation electrode 32A to the center C3 of the third radiation electrode 33A.

The fourth radiation electrode 34 is adjacent to the third radiation electrode 33A in a direction intersecting the direction of the first linear line L1 within the main surface 2a, and is adjacent to the second radiation electrode 32A in a direction intersecting the direction of the second linear line L2 within the main surface 2a. In the present embodiment, the direction in which the fourth and third radiation electrodes 34 and 33A are adjacent to each other is orthogonal to the direction of the first linear line L1 within the main surface 2a, and matches the first direction D1. The direction in which the fourth and second radiation electrodes 34 and 32A are adjacent to each other is orthogonal to the direction of the second linear line L2 within the main surface 2a, and matches the second direction D2.

The first side 34a of the fourth radiation electrode 34 faces the second side 32b of the second radiation electrode 32A with a predetermined distance therebetween. The first side 34a of the fourth radiation electrode 34 and the second side 32b of the second radiation electrode 32A are parallel to each other. The third side 34c of the fourth radiation electrode 34 faces the fourth side 33d of the third radiation electrode 33A with a predetermined distance therebetween. The third side 34c of the fourth radiation electrode 34 and the fourth side 33d of the third radiation electrode 33A are parallel to each other.

The distance between the fourth and second radiation electrodes 34 and 32A is smaller than the size of each of the second and fourth radiation electrodes 32A and 34 in the second direction D2. The distance between the fourth and second radiation electrodes 34 and 32A is the distance between the first side 34a of the fourth radiation electrode 34 and the second side 32b of second radiation electrode 32A. The size of the fourth radiation electrode 34 in the second direction D2 is a distance between the first and second sides 34a and 34b, and the size of the second radiation electrode 32A in the second direction D2 is a distance between the first and second sides 32a and 32b. This configuration enables electromagnetic field coupling, that is, capacitive coupling, between the fourth and second radiation electrodes 34 and 32A. Thus, when a current flows along the second side 32b of the second radiation electrode 32A, the current can flow in the same direction along the first side 34a of the fourth radiation electrode 34.

The distance between the fourth and third radiation electrodes 34 and 33A is smaller than any of the sizes of the third and fourth radiation electrodes 33A and 34 in the first direction D1. The distance between the fourth and third radiation electrodes 34 and 33A is the distance between the third side 34c of the fourth radiation electrode 34 and the fourth side 33d of the third radiation electrode 33A. The size of the fourth radiation electrode 34 in the first direction D1 is a distance between the third and fourth sides 34c and 34d, and the size of the third radiation electrode 33A in the first direction D1 is a distance between the third and fourth sides 33c and 33d. This configuration enables electromagnetic field coupling, that is, capacitive coupling, between the fourth and third radiation electrodes 34 and 33A. Therefore, when a current flows along the fourth side 33d of the third radiation electrode 33A, the current can flow in the same direction along the third side 34c of the fourth radiation electrode 34.

The size of the fourth radiation electrode 34 is determined according to a frequency band used for wireless communication. In the present embodiment, the fourth radiation electrode 34 corresponds to the same first frequency band as the first radiation electrode 31A. Therefore, the size difference between the second and fourth radiation electrodes 32A and 34 and the size difference between the third and fourth radiation electrodes 33A and 34 are larger than the size difference between the first and fourth radiation electrodes 31A and 34.

In the present embodiment, since the first frequency band is higher than the second frequency band, the sizes of the first and fourth radiation electrodes 31A and 34 are smaller than the sizes of the second and third radiation electrodes 32A and 33A.

Because the size of the fourth radiation electrode 34 is smaller than the size of the second radiation electrode 32A, the second side 32b of the second radiation electrode 32A facing the fourth radiation electrode 34 is longer than the first side 34a of the fourth radiation electrode 34 facing the second radiation electrode 32A. This makes it possible to improve an amount of power supplied from the second radiation electrode 32A to the fourth radiation electrode 34, and antenna efficiency in the fourth radiation electrode 34 can be improved.

Because the size of the fourth radiation electrode 34 is larger than the size of the third radiation electrode 33A, the fourth side 33d of the third radiation electrode 33A facing the fourth radiation electrode 34 is longer than the third side 34c of the fourth radiation electrode 34 facing the third radiation electrode 33A. This makes it possible to improve an amount of power supplied from the third radiation electrode 33A to the fourth radiation electrode 34, and antenna efficiency in the fourth radiation electrode 34 can be improved.

Next, an operation of the antenna substrate 1H will be described briefly. The processing circuit 6 outputs the horizontally polarized (H-polarized) first signal S1 to the first feed line 41 and outputs the vertically polarized (V-polarized) second signal S2 to the second feed line 42.

It is assumed that the first and second signals S1 and S2 are signals with a first frequency band.

The first signal S1 reaches the first radiation electrode 31A through the first feed line 41, and is radiated as a horizontally polarized radio wave by the first radiation electrode 31A. Part of first signal S1 passes through the first radiation electrode 31A, and reaches the third radiation electrode 33A through the fourth feed line 44. The first signal S1 propagating along the fourth side 33d of the third radiation electrode 33A reaches the fourth radiation electrode 34 by electromagnetic field coupling between the third and fourth radiation electrodes 33A and 34, and is radiated as a horizontally polarized radio wave by the fourth radiation electrode 34.

The second signal S2 reaches the first radiation electrode 31A through the second feed line 42, and is radiated as a vertically polarized radio wave by the first radiation electrode 31A. Part of the second signal S2 passes through the first radiation electrode 31A, and reaches the second radiation electrode 32A through the third feed line 43. The second signal S2 propagating along the second side 32b of the second radiation electrode 32A reaches the fourth radiation electrode 34 by electromagnetic field coupling between the second and fourth radiation electrodes 32A and 34, and is radiated as a vertically polarized radio wave by the fourth radiation electrode 34.

As described above, when the first and second signals S1 and S2 are signals with the first frequency band, each of the first and fourth radiation electrodes 31A and 34 alone functions as a dual-polarized antenna.

It is assumed that the first and second signals S1 and S2 are signals with the second frequency band. In this case, the first signal S1 reaches the first radiation electrode 31A through the first feed line 41, further passes through the first radiation electrode 31A, reaches the third radiation electrode 33A through the fourth feed line 44, and is radiated as a horizontally polarized radio wave by the third radiation electrode 33A. The second signal S2 reaches the first radiation electrode 31A through the second feed line 42, further passes through the first radiation electrode 31A, reaches the second radiation electrode 32A through the third feed line 43, and is radiated as a vertically polarized radio wave by the second radiation electrode 32A. In this way, a set of second and third radiation electrodes 32A and 33A functions as a dual-polarized antenna.

In the antenna substrate 1H, the fourth radiation electrode 34 can improve an antenna gain in the frequency band corresponding to the size of the fourth radiation electrode 34. Since the fourth radiation electrode 34 alone can function as a dual-polarized antenna, an area required for disposing the dual-polarized antenna can be reduced as compared with a case where the dual-polarized antenna includes a plurality of radiation electrodes.

### 1.9.2 Effects and Like

The antenna substrate 1H further includes the fourth planar radiation electrode 34. The fourth radiation electrode 34 is located opposite to the first radiation electrode 31A with respect to the third linear line L5 connecting the center C2 of the second radiation electrode 32A to the center C3 of the third radiation electrode 33A. This configuration enables an increase in antenna gain in a frequency band corresponding to the size of the fourth radiation electrode 34.

The fourth radiation electrode 34 is adjacent to the third radiation electrode 33A in the direction intersecting the direction of the first linear line L1 within the main surface 2a, and is adjacent to the second radiation electrode 32A in the direction intersecting the direction of the second linear line L2 within the main surface 2a. In this configuration, the fourth radiation electrode 34 alone can function as the dual-polarized antenna, and the area required for disposing the dual-polarized antenna can be reduced as compared with a case where the dual-polarized antenna includes a plurality of radiation electrodes.

### 1.10 Tenth Embodiment

### 1.10.1 Configuration

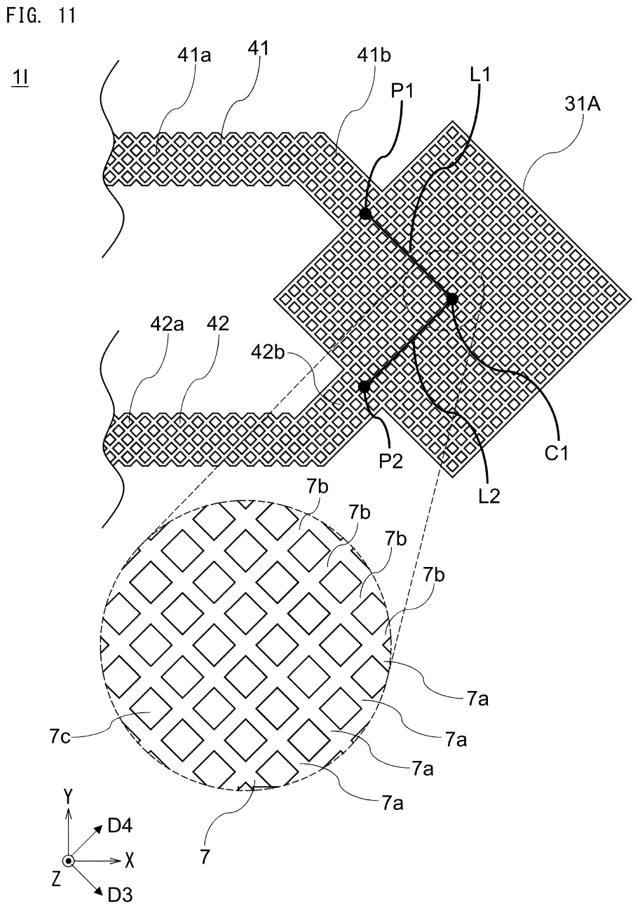

FIG. 11 is an enlarged view of an antenna substrate 1I according to a tenth embodiment. Similarly to the antenna substrate 1D, the antenna substrate 1I includes the dielectric substrate 2, the first radiation electrode 31, the second radiation electrode 32, the third radiation electrode 33, the first feed line 41, the second feed line 42, the grounding electrode 5, and the processing circuit 6.

In particular, FIG. 11 is an enlarged view of the first radiation electrode 31 and the first and second feed lines 41 and 42 of the antenna substrate 1I. The antenna substrate 1I is different from the antenna substrate 1D in that the first to third radiation electrodes 31 to 33, the first and second feed lines 41 and 42, and the grounding electrode 5 have the same mesh structure 7.

The mesh structure 7 includes a plurality of first linear conductors 7a and a plurality of second linear conductors 7b intersecting the plurality of first linear conductors 7a. The plurality of first linear conductors 7a are parallel to each other. The plurality of first linear conductors 7a extend in the third direction. The plurality of second linear conductors 7b are parallel to each other. The plurality of second linear conductors 7b extend in a fourth direction different from the third direction.

In the mesh structure 7, the adjacent first and second linear conductors 7a and 7b define one opening 7c. The plurality of openings 7c are regularly arranged in the third and fourth directions. Due to presence of the plurality of openings 7c, the visibility of the mesh structure 7 itself is reduced. That is, it is difficult to see the mesh structure 7 with the naked eye. As an example, the width of the first linear conductor 7a and the width of the second linear conductor 7b are 1 μm, and an interval between the first linear conductors 7a and an interval between the second linear conductors 7b are 100 μm. A ratio of a total area of the plurality of openings 7c to an area of a region where the mesh structure 7 is disposed may be 80% or more. Transmittance of visible light of the mesh structure 7 may be 80% or more.

In this way, since the first to third radiation electrodes 31 to 33, the first and second feed lines 41 and 42, and the grounding electrode 5 have the mesh structure 7, visibility of the first to third radiation electrodes 31 to 33, the first and second feed lines 41 and 42, and the grounding electrode 5 can be reduced.

The third direction of the mesh structure 7 is parallel to the direction D3 in which the first feed line 41 is connected to the first connection point P1. The direction D3 in which the first feed line 41 is connected to the first connection point P1 corresponds to a length direction of the second portion 41b connected to the first connection point P1 in the first feed line 41. The length direction of the second portion 41b of the first feed line 41 matches the direction of the first linear line L1 connecting the first connection point P1 to the center C1 of the first radiation electrode 31. The fourth direction of the mesh structure 7 is parallel to the direction D4 in which the second feed line 42 is connected to the second connection point P2. The direction D4 in which the second feed line 42 is connected to the second connection point P2 corresponds to a length direction of the second portion 42b of the second feed line 42. The length direction of the second portion 42b of the second feed line 42 matches the direction of the first linear line L1 connecting the first connection point P1 to the center C1 of the first radiation electrode 31.

In the first radiation electrode 31, a direction in which the current flows from the first feed line 41 to the first radiation electrode 31 matches a direction in which the first linear conductor 7a extends. The direction in which the current flows from the second feed line 42 to the first radiation electrode 31 matches a direction in which the second linear conductor 7b extends. Accordingly, a current loss in the first radiation electrode 31 is inhibited, and an antenna gain can be improved.

Since the second radiation electrode 32 is electromagnetically coupled to the first radiation electrode 31, a current flows to the second radiation electrode 32 in a direction in which the current flows from the first feed line 41 to the first radiation electrode 31, that is, in the same direction as the direction D3 in which the first feed line 41 is connected to the first connection point P1. Therefore, since the direction in which the current flows from the first feed line 41 to the first radiation electrode 31 matches the direction in which the first linear conductor 7a extends, a current loss in the second radiation electrode 32 is inhibited, and an antenna gain can be improved.

Since the third radiation electrode 33 is electromagnetically coupled to the first radiation electrode 31, a current flows through the third radiation electrode 33 in the direction in which the current flows from the second feed line 42 to the first radiation electrode 31, that is, in the same direction as the direction D4 in which the second feed line 42 is connected to the second connection point P2. Therefore, since the direction in which the current flows from the first feed line 41 to the first radiation electrode 31 matches the direction in which the first linear conductor 7a extends, a current loss in the third radiation electrode 33 is inhibited, and an antenna gain can be improved.

The antenna substrate 1I is different from the antenna substrate 1D in that the dielectric layer 20 of the dielectric substrate 2 is transparent. The dielectric layer 20 can be formed of, for example, well-known glass or transparent resin. As the transparent resin, organic insulating materials such as polyester-based resins such as polyethylene terephthalate, acryl-based resins such as polymethyl methacrylate, polycarbonate-based resins, polyimide-based resins, or polyolefin-based resins such as cycloolefin polymers, and cellulose-based resin materials such as triacetyl cellulose can be used.

In the antenna substrate 1I, visibility of the dielectric substrate 2, the first to third radiation electrodes 31 to 33, the first and second feed lines 41,42, and the grounding electrode 5 can be reduced. Therefore, the antenna substrate 1I can be disposed to overlap, for example, a display or the like seen by a person, and the degree of freedom in the disposition of the antenna substrate 1I can be improved.

### 1.10.2 Effects and Like

In the antenna substrate 1I described above, the first radiation electrode 31 has the mesh structure 7. The mesh structure 7 includes the plurality of first linear conductors 7a extending in the third direction and parallel to each other, and the plurality of second linear conductors 7b extending in the fourth direction different from the third direction to intersect the plurality of first linear conductors 7a and parallel to each other. The third direction is parallel to the direction D3 in which the first feed line 41 is connected to the first connection point P1. The fourth direction is parallel to the direction D4 in which the second feed line 42 is connected to the second connection point P2. This configuration can reduce visibility of the first radiation electrode 31. Further, in this configuration, a current loss in the first radiation electrode 31 is inhibited and an antenna gain can be improved.

In the antenna substrate 1I, the second and third radiation electrodes 32 and 33 have the same mesh structure 7 as the mesh structure 7 of the first radiation electrode 31. This configuration can reduce the visibility of the second and third radiation electrodes 32 and 33. Further, in this configuration, a current loss in the second and third radiation electrodes 32 and 33 is inhibited and an antenna gain of the second and third radiation electrodes 32 and 33 can be improved.

### 1.11 Eleventh Embodiment

### 1.11.1 Configuration

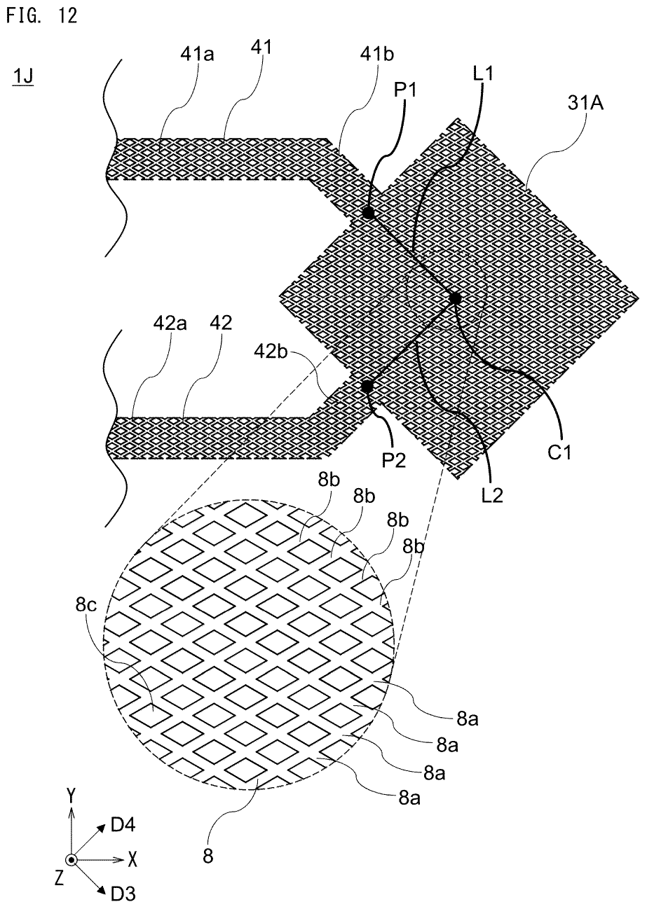

FIG. 12 is an enlarged view of an antenna substrate 1J according to an eleventh embodiment. Similarly to the antenna substrate 1D, the antenna substrate 1J includes the dielectric substrate 2, the first radiation electrode 31, the second radiation electrode 32, the third radiation electrode 33, the first feed line 41, the second feed line 42, the grounding electrode 5, and the processing circuit 6.

In particular, FIG. 12 is an enlarged view of the first radiation electrode 31 and the first and second feed lines 41 and 42 of the antenna substrate 1J. The antenna substrate 1J is different from the antenna substrate 1D in that the first to third radiation electrodes 31 to 33, the first and second feed lines 41 and 42, and the grounding electrode 5 have the mesh structure 8.

The mesh structure 8 includes a plurality of first linear conductors 8a and a plurality of second linear conductors 8b intersecting the plurality of first linear conductors 8a. The plurality of first linear conductors 8a are parallel to each other. The plurality of first linear conductors 8a extend in the third direction. The plurality of second linear conductors 8b are parallel to each other. The plurality of second linear conductors 8b extend in a fourth direction different from the third direction. In the present embodiment, each of the third and fourth directions is a direction different from any of the directions D3 and D4. For example, the third direction is a direction inclined by 30° with respect to the X direction, and the fourth direction is a direction inclined by 60° with respect to the third direction. Accordingly, as compared with the mesh structure 7, it is less conspicuous than the mesh structure 8, and the visibility of the mesh structure 8 is reduced.

In the mesh structure 8, the adjacent first linear conductors 8a and the adjacent second linear conductors 8b define one opening 8c. The plurality of openings 8c are regularly arranged in the third and fourth directions. Due to presence of the plurality of openings 8c, visibility of the mesh structure 8 itself is reduced. That is, it is difficult to see the mesh structure 8 with the naked eye. As an example, a width of the first linear conductor 8a and a width of the second linear conductor 8b are 1 μm, and an interval between the first linear conductors 8a and an interval between the second linear conductors 8b are 100 μm. A ratio of a total area of the plurality of openings 8c to an area of a region where the mesh structure 8 is disposed may be 80% or more. Transmittance of visible light of the mesh structure 8 may be 80% or more.

### 1.11.2 Effects and Like

In the antenna substrate 1J described above, the first to third radiation electrodes 31 to 33 have the mesh structure 8. This configuration can reduce visibility of the first to third radiation electrodes 31 to 33.

### 1.12 Twelfth Embodiment

### 1.12.1 Configuration

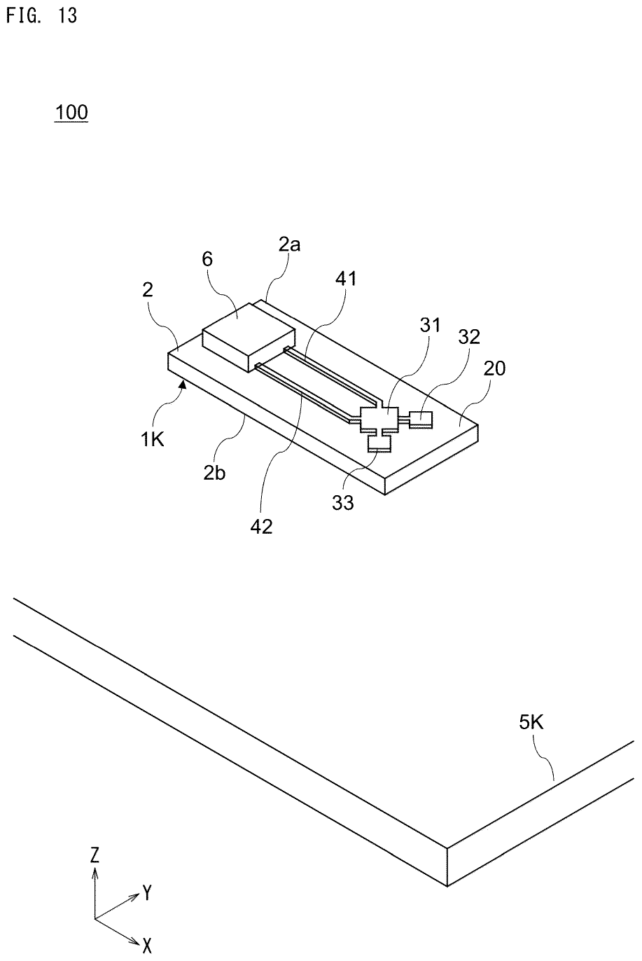

FIG. 13 is a perspective view of an antenna device 100 according to a twelfth embodiment. The antenna device 100 includes an antenna substrate 1K and a grounding electrode 5K.

Similarly to the antenna substrate 1 according to the first embodiment, the antenna substrate 1K includes the dielectric substrate 2, the first radiation electrode 31, the second radiation electrode 32, the third radiation electrode 33, the first feed line 41, the second feed line 42, and the processing circuit 6, but does not include the grounding electrode 5.

The grounding electrode 5K is located on the side opposite to the main surface 2a in the dielectric substrate 2. The grounding electrode 5K is disposed, for example, on a motherboard of an electronic device on which the antenna substrate 1K is mounted. As the grounding electrode 5K, an electrode in a display device can also be used. In this case, in the antenna substrate 1K, the first to third radiation electrodes 31 to 33 and the first and second feed lines 41 and 42 may each have the mesh structure 7 or 8, and the dielectric layer 20 of the dielectric substrate 2 may be transparent.

### 1.12.2 Effects and Like

The antenna device 100 described above includes the antenna substrate 1K and the grounding electrode 5K on the side of the dielectric substrate 2 opposite to the main surface 2a. This configuration can be applied to a dual-polarized antenna corresponding to a plurality of frequency bands, and can reduce the area required for disposing the radiation electrodes. Since it is not necessary to provide a grounding electrode on the antenna substrate 1K itself, the thickness of the antenna substrate 1K can be reduced. Processing of the antenna substrate 1K can be facilitated. The grounding electrode 5K can be disposed away from the antenna substrate 1K, and a distance between the first and third radiation electrodes 31 and 33 and the grounding electrode 5K can be secured as compared with a case where the grounding electrode 5K is disposed on the antenna substrate 1K, so that a band of a patch antenna formed by the first to third radiation electrodes 31 to 33 and the grounding electrode 5K can be widened.

### 2. Modifications

Embodiments of the present disclosure are not limited to the above embodiments. As long as the effects of the present disclosure can be achieved, the above embodiments can be variously modified according to design or the like. The modifications of the above embodiments will be listed below. The modifications to be described below can be appropriately combined and applied.

Hereinafter, except for a case where a specific embodiment is mentioned, the reference numerals used in the first embodiment will be referred to, even when any of the first to twelfth embodiments described above can be applied, but this is merely for simplifying the description, and is not intended to exclude application to the second to twelfth embodiments.

In a modification, the shapes of the first to the third radiation electrodes 31 to 33 are not particularly limited. In the first embodiment, the outer shapes of the first to third radiation electrodes 31 to 33 are square as viewed in the thickness direction of the dielectric substrate 2, but the present disclosure is not limited thereto. The outer shapes may be rectangular shapes, other polygonal shapes, or circular shapes, and may be appropriately changed in consideration of target antenna characteristics and the like. The first to third radiation electrodes 31 to 33 are not necessarily required to be similar. As an example, the first radiation electrode 31 may have a circular shape, the second and third radiation electrodes 32 and 33 may have a quadrangular shape, and the first to third radiation electrodes 31 to 33 may have shapes that are not similar to each other.

In a modification, the shapes of the first and second feed lines 41 and 42 are not particularly limited. The first and second feed lines 41 and 42 may be appropriately changed according to the arrangement of the first to third radiation electrodes 31 to 33 and the processing circuit 6 in the dielectric substrate 2, and may include not only the main surface 2a of the dielectric substrate 2 but also a portion passing through other than the main surface 2a of the dielectric substrate 2, for example, a portion penetrating through the dielectric substrate 2.

In the third and seventh embodiments, the first connection point P3 between the first and second feed lines 41B and 32B may be located on the first side 32a of the second radiation electrode 32B instead of the third side 32c. The second connection point P4 between the second and third feed lines 42B and 33B may be located on the third side 33c of the third radiation electrode 33B instead of the first side 33a. In this case, the first radiation electrode 31B is adjacent to the third radiation electrode 33B in the first direction in which the first linear line L3 connecting the first connection point P3 to the center C2 of the second radiation electrode 32B intersects within the main surface 2a, intersects the second linear line L4 connecting the second connection point P4 to the center C3 of the third radiation electrode 33B within the main surface 2a, and is adjacent to the second radiation electrode 32B in the second direction D2 different from the first direction D1.

In a modification, the shape, size, number, and position of fourth radiation electrode 34 may be appropriately changed.

For example, in the antenna substrate 1H, the position of the fourth radiation electrode 34 may be changed to be adjacent to the fourth side 32d of the second radiation electrode 32A. The fourth radiation electrode 34 is located on the side opposite to the first radiation electrode 31A with respect to the third linear line L5 and is adjacent to the second radiation electrode 32A, but is not adjacent to the third radiation electrode 33A. In the antenna substrate 1H, the fourth radiation electrode 34 may be disposed to be adjacent to the second side 33b of the third radiation electrode 33A. The fourth radiation electrode 34 is located on the side opposite to the first radiation electrode 31A with respect to the third linear line L5 and is adjacent to the third radiation electrode 33A, but is not adjacent to the second radiation electrode 32A. The antenna substrate 1H may include the plurality of fourth radiation electrodes 34 at different positions.

For example, in the antenna substrate 1F, the fourth radiation electrode 34 may be disposed adjacent to the first side 32a of the second radiation electrode 32B. The fourth radiation electrode 34 is located on the opposite side to the first radiation electrode 31B with respect to the third linear line connecting the center C2 of the second radiation electrode 32B to the center C3 of the third radiation electrode 33B and is adjacent to the second radiation electrode 32B, but is not adjacent to the third radiation electrode 33B. In the antenna substrate 1F, the fourth radiation electrode 34 may be disposed adjacent to the third side 33c of the third radiation electrode 33B. The fourth radiation electrode 34 is located on the opposite side to the first radiation electrode 31B with respect to the third linear line connecting the center C2 of the second radiation electrode 32B to the center C3 of the third radiation electrode 33B and is adjacent to the third radiation electrode 33B, but is not adjacent to the second radiation electrode 32B. The antenna substrate 1F may include the plurality of fourth radiation electrodes 34 at different positions.

In a modification, the size of the fourth radiation electrode 34 is not particularly limited. For example, the fourth radiation electrode 34 may have a size corresponding to either the first frequency band or the second frequency band, or may have a size corresponding to a third frequency band different from the first and second frequency bands.

In a modification, the fourth radiation electrode 34 may be directly connected to the second radiation electrode 32 or the third radiation electrode 33, or may be electromagnetically coupled.

In a modification, the mesh structure 7 may also be applied to the first to third radiation electrodes 31 to 33 and the first to fourth feed lines 41 to 44 of the antenna substrate 1. Even in this case, the third and fourth directions of the mesh structure 7 may be parallel to the direction D3 in which the first feed line 41 is connected to the first connection point P1 and the direction D4 in which the second feed line 42 is connected to the second connection point P2. In the antenna substrate 1, since the second and third radiation electrodes 32 and 33 are linearly connected to the first radiation electrode 31, a current flows in the second radiation electrode 32 in the same direction as the direction D4, and a current flows in the third radiation electrode 33 in the same direction as the direction D3. Therefore, since the third and fourth directions of the mesh structure 7 are parallel to the directions D3 and D4, respectively, current losses in the second and third radiation electrodes 32 and 33 are inhibited, and an antenna gain can be improved.

In a modification, the mesh structure 7 may also be applied to the first to third radiation electrodes 31B to 33B and the first to fourth feed lines 41B to 44B of the antenna substrates 1B and 1F. Even in this case, the third direction of the mesh structure 7 is parallel to the direction in which the first feed line 41B is connected to the first connection point P3. The direction in which the first feed line 41B is connected to the first connection point P3 corresponds to the length direction of the second portion 41b connected to the first connection point P3 in the first feed line 41B. The length direction of the second portion 41b of the first feed line 41B matches the direction of the first linear line L3 connecting the first connection point P3 to the center C2 of the second radiation electrode 32B. The fourth direction of the mesh structure 7 is parallel to the direction in which the second feed line 42B is connected to the second connection point P4. The direction in which the second feed line 42B is connected to the second connection point P4 corresponds to the length direction of the second portion 42b of the second feed line 42B. The length direction of the second portion 42b of the second feed line 42B matches the direction of the second linear line L4 connecting the second connection point P4 to the center C3 of the third radiation electrode 33B.

In a modification, the third direction of the mesh structure 7 is not necessarily parallel to the direction D3 in which the first feed line 41 is connected to the first connection point P1, and may be parallel to a direction (X direction) in which the first portion 41a of the first feed line 41 or the first portion 42a of the second feed line 42 extends. In this case, the fourth direction of the mesh structure 7 may be parallel to the width direction (Y direction) of the first portion 41a of the first feed line 41 or the first portion 42a of the second feed line 42. That is, the third and fourth directions of the mesh structure 7 may be appropriately changed.

In the antenna substrate 1B, in the first radiation electrode 31B, due to the direct connection with the second and third radiation electrodes 32B and 33B, a direction in which the current flows from third feed line 43B to the first radiation electrode 31B matches the direction in which first linear conductor 7a extends, and a direction in which a current flows from fourth feed line 44B to the first radiation electrode 31B matches the direction in which second linear conductor 7b extends. Accordingly, a current loss in the first radiation electrode 31B is inhibited, and an antenna gain can be improved.

In the antenna substrate 1F, in the first radiation electrode 31B, due to the direct connection with the second and third radiation electrodes 32B and 33B, the direction in which a current flows from the third feed line 43B to the first radiation electrode 31B matches the direction in which first linear conductor 7a extends, and a direction in which a current flows from the fourth feed line 44B to the first radiation electrode 31B matches the direction in which the second linear conductor 7b extends. Accordingly, a current loss in the first radiation electrode 31B is inhibited, and an antenna gain can be improved.

In both the antenna substrates 1B and 1F, when the second and third radiation electrodes 32B and 33B have the same mesh structure 7 as the first radiation electrode 31B, the direction in which the current flows from the first feed line 41B to the second radiation electrode 32B matches the direction in which the second linear conductor 7b extends. The direction in which the current flows from the second feed line 42B to the third radiation electrode 33B matches the direction in which the first linear conductor 7a extends. Accordingly, a current loss in the second and third radiation electrodes 32B and 33B is inhibited, and an antenna gain can be improved.

In a modification, all of the first to third radiation electrodes 31 to 33, the first to fourth feed lines 41 to 44, and the grounding electrode 5 may not have the mesh structure 7 or 8. At least one of the first to third radiation electrodes 31 to 33, the first to fourth feed lines 41 to 44, and the grounding electrode 5 may have the mesh structure 7 or 8. Further, all or a part of at least one of the first to third radiation electrodes 31 to 33, the first to fourth feed lines 41 to 44, and the grounding electrode 5 may have the mesh structure 7 or 8.

In a modification, the structures and forming methods for the mesh structures 7 and 8 are not particularly limited. The mesh structures 7 and 8 may be formed by patterning a conductor, may be formed by printing, may be formed by punching a metal plate, or may be formed using a metal mesh.

In a modification, a frequency band used for wireless communication in the antenna substrate 1 is not particularly limited. The frequency band may be selected from well-known frequency bands such as a frequency band of wireless communication by Wi-Fi, a frequency band of wireless communication by UWB, a frequency band of Bluetooth (registered trademark), a frequency band of wireless communication by Wi-Fi, a midband of 2G (second generation mobile communication) standard, a low band of 4G (fourth generation mobile communication) standard, and a low band of 5G (fifth generation mobile communication) standard. Examples of the frequency band of wireless communication using Wi-Fi include a frequency band around 2.4 GHz (for example, 2.4 GHz to 2.5 GHz) and a frequency band around 5 GHz (for example, 5.15 GHz to 5.8 GHz). The 2G standard is, for example, the Global System for Mobile Communications (GSM) (registered trademark) standard. The 4G standard is, for example, the 3GPP (registered trademark) Long Term Evolution (LTE) standard. The 5G standard is, for example, 5G New Radio (NR). The frequency band may be selected from frequency bands used for various communication standards such as a wireless LAN, specific low power radio, and near field communication.

### 3. Aspects

As apparent from the above embodiments and modifications, the present disclosure includes the following aspects.

### Aspect 1

An antenna substrate comprising:
a dielectric substrate having a main surface; and
first to third planar radiation electrodes and first and second feed lines located on the main surface of the dielectric substrate,
wherein a size difference between the first and second radiation electrodes and a size difference between the first and third radiation electrodes are larger than a size difference between the second and third radiation electrodes,
the first and second feed lines are connected to the first radiation electrode at first and second connection points different from each other, and
the first radiation electrode is adjacent to the second radiation electrode in a first direction intersecting a direction of a first linear line connecting the first connection point to a center of the first radiation electrode within the main surface, intersects a direction of a second linear line connecting the second connection point to a center of the first radiation electrode within the main surface, and is adjacent to the third radiation electrode in a second direction different from the first direction.

### Aspect 2

An antenna substrate comprising:
a dielectric substrate having a main surface; and
first to third planar radiation electrodes and first and second feed lines located on the main surface of the dielectric substrate,
a size difference between the first and second radiation electrodes and a size difference between the first and third radiation electrodes are larger than a size difference between the second and third radiation electrodes,
the first feed line is connected to the second radiation electrode at a first connection point,
the second feed line is connected to the third radiation electrode at a second connection point, and
the first radiation electrode is adjacent to one of the second and third radiation electrodes in a first direction intersecting a first linear line connecting the first connection point to a center of the second radiation electrode within the main surface, intersects a second linear line connecting the second connection point and a center of the third radiation electrode within the main surface, and is adjacent to the other of the second and third radiation electrodes in a second direction different from the first direction.

### Aspect 3

The antenna substrate according to aspect 1 or 2, wherein the first and second feed lines transmit signals in an identical frequency band.

### Aspect 4

The antenna substrate according to any one of aspects 1 to 3, further comprising:
a third feed line connecting the first radiation electrode to the second radiation electrode; and
a fourth feed line connecting the first radiation electrode to the third radiation electrode.

### Aspect 5

The antenna substrate according to aspect 4, wherein a size of the first radiation electrode is larger than a size of the second radiation electrode and a size of the third radiation electrode.

### Aspect 6

The antenna substrate according to aspect 4, wherein a size of the first radiation electrode is smaller than a size of the second radiation electrode and a size of the third radiation electrode.

### Aspect 7

The antenna substrate according to any one of aspects 1 to 3,
wherein the first radiation electrode is not directly connected to either the second radiation electrode or the third radiation electrode,
a distance between the first and second radiation electrodes is less than a size of each of the first and second radiation electrodes in the first direction, and
a distance between the first and third radiation electrodes is less than either a size of the first radiation electrode or a size of the third radiation electrode in the second direction.

### Aspect 8

The antenna substrate according to aspect 7, wherein a size of the first radiation electrode is larger than a size of the second radiation electrode and a size of the third radiation electrode when viewed in a thickness direction of the dielectric substrate.

### Aspect 9

The antenna substrate according to aspect 7, wherein the size of the first radiation electrode is smaller than the size of the second radiation electrode and the size of the third radiation electrode when viewed in a thickness direction of the dielectric substrate.

### Aspect 10

The antenna substrate according to any one of aspects 1 to 9, further comprising:
a planar fourth radiation electrode on a side opposite to the first radiation electrode with respect to a third linear line connecting a center of the second radiation electrode to a center of the third radiation electrode.

### Aspect 11

The antenna substrate according to any one of aspects 1 to 10, further comprising:
a planar fourth radiation electrode adjacent to the third radiation electrode in a direction intersecting the direction of the first linear line within the main surface and adjacent to the second radiation electrode in a direction intersecting the direction of the second linear line within the main surface.

### Aspect 12

The antenna substrate according to any one of aspects 1 to 11, wherein at least one of the first to third radiation electrodes has a mesh structure.

### Aspect 13

The antenna substrate according to any one of aspects 1 to 12,
wherein the first radiation electrode has a mesh structure,
the mesh structure includes a plurality of first linear conductors extending in a third direction and parallel to each other and a plurality of second linear conductors extending in a fourth direction different from the third direction and parallel to each other to intersect the plurality of first linear conductors,
the third direction is parallel to a direction in which the first feed line is connected to the first connection point, and
the fourth direction is parallel to a direction in which the second feed line is connected to the second connection point.

### Aspect 14

The antenna substrate according to aspect 13, wherein the second and third radiation electrodes have the same mesh structure as the first radiation electrode.

### Aspect 15

The antenna substrate according to any one of aspects 1 to 14,
wherein each of the first to third radiation electrodes includes first and second sides opposed to each other in a direction of the first linear line, and third and fourth sides opposed to each other in a direction of the second linear line, and
a size of each of the first to third radiation electrodes is defined by a distance between the first and second sides and a distance between the third and fourth sides.

### Aspect 16

The antenna substrate according to any one of aspects 1 to 15,
wherein the first to third radiation electrodes are similar to each other when viewed in a thickness direction of the dielectric substrate, and
a size difference between the first to third radiation electrodes is determined by a similarity ratio.

### Aspect 17

The antenna substrate according to any one of aspects 1 to 16, wherein a size of the second radiation electrode is equal to a size of the third radiation electrode.

### Aspect 18

The antenna substrate according to any one of aspects 1 to 17, wherein the first and second linear lines are orthogonal to each other.

### Aspect 19

The antenna substrate according to any one of aspects 1 to 18, further comprising:
a grounding electrode on a side opposite to the main surface in the dielectric substrate.

### Aspect 20

An antenna device comprising:
the antenna substrate according to any one of aspects 1 to 18; and
a grounding electrode on a side opposite to the main surface in the dielectric substrate.

Aspects 2 to 19 are optional and not essential.

### INDUSTRIAL APPLICABILITY

The present disclosure can be applied to antenna substrates and antenna devices. In particular, the present disclosure is applicable to an antenna substrate applicable to a dual-polarized antenna corresponding to a plurality of frequencies, and an antenna device including the antenna substrate.

### REFERENCE SIGNS LIST

1, 1A to 1K Antenna Substrate
2 Dielectric Substrate
2a Main Surface
5, 5K Grounding Electrode
7 Mesh Structure
7a First Linear Conductor
7b Second Linear Conductor
8 Mesh Structure
8a First Linear Conductor
8b Second Linear Conductor
31, 31A to 31C First Radiation Electrode
32, 32a To 32c Second Radiation Electrode
33, 33a To 33c Third Radiation Electrode
34 Fourth Radiation Electrode
41, 41b First Feed Line
42, 42b Second Feed Line
43, 43b Third Feed Line
44, 44b Fourth Feed Line
100 Antenna Device

What is claimed is:

1. An antenna substrate comprising:
a dielectric substrate having a main surface; and
first, second, and third planar radiation electrodes and first and second feed lines located on the main surface of the dielectric substrate, wherein
a size difference between the first and second planar radiation electrodes and a size difference between the first and third planar radiation electrodes are larger than a size difference between the second and third planar radiation electrodes,
the first and second feed lines are connected to at least one of the first, second, or third planar radiation electrode at first and second connection points different from each other, and
the first planar radiation electrode is adjacent to the second planar radiation electrode in a first direction, and
the first planar radiation electrode is adjacent to the third planar radiation electrode in a second direction different from the first direction.

2. The antenna substrate according to claim 1, wherein
the first and second feed lines are connected to the first radiation electrode at first and second connection points different from each other, respectively,
the first direction intersects a direction of a first linear line connecting the first connection point to a center of the first planar radiation electrode within the main surface, and
the second direction intersects a direction of a second linear line connecting the second connection point to a center of the first radiation electrode within the main surface.

3. The antenna substrate according to claim 1, wherein, comprising:
the first feed line is connected to the second radiation electrode at a first connection point,
the second feed line is connected to the third radiation electrode at a second connection point, and
the first direction intersects a first linear line connecting the first connection point to a center of the second radiation electrode within the main surface, and
the second direction intersects a second linear line connecting the second connection point and a center of the third radiation electrode within the main surface.

4. The antenna substrate according to claim 1, wherein the first and second feed lines transmit signals in an identical frequency band.

5. The antenna substrate according to claim 1, further comprising:
a third feed line connecting the first planar radiation electrode to the second planar radiation electrode; and
a fourth feed line connecting the first planar radiation electrode to the third planar radiation electrode.

6. The antenna substrate according to claim 5, wherein a size of the first planar radiation electrode is larger than a size of the second planar radiation electrode and a size of the third planar radiation electrode.

7. The antenna substrate according to claim 5, wherein a size of the first planar radiation electrode is smaller than a size of the second planar radiation electrode and a size of the third planar radiation electrode.

8. The antenna substrate according to claim 1,
wherein the first planar radiation electrode is not directly connected to either the second planar radiation electrode or the third planar radiation electrode,
a distance between the first and second planar radiation electrodes is less than a size of each of the first and second radiation electrodes in the first direction, and
a distance between the first and third planar radiation electrodes is less than either a size of the first planar radiation electrode or a size of the third planar radiation electrode in the second direction.

9. The antenna substrate according to claim 8, wherein a size of the first radiation electrode is larger than a size of the second planar radiation electrode and a size of the third planar radiation electrode when viewed in a thickness direction of the dielectric substrate.

10. The antenna substrate according to claim 8, wherein the size of the first planar radiation electrode is smaller than the size of the second planar radiation electrode and the size of the third planar radiation electrode when viewed in a thickness direction of the dielectric substrate.

11. The antenna substrate according to claim 1, further comprising:
a planar fourth planar radiation electrode on a side opposite to the first planar radiation electrode with respect to a third linear line connecting a center of the second planar radiation electrode to a center of the third planar radiation electrode.

12. The antenna substrate according to claim 1, further comprising:
a fourth planar radiation electrode adjacent to the third planar radiation electrode in a direction intersecting the direction of the first linear line within the main surface and adjacent to the second planar radiation electrode in a direction intersecting the direction of the second linear line within the main surface.

13. The antenna substrate according to claim 1, wherein at least one of the first to third planar radiation electrodes has a mesh structure.

14. The antenna substrate according to claim 1,
wherein the first planar radiation electrode has a mesh structure,
the mesh structure includes a plurality of first linear conductors extending in a third direction and parallel to each other and a plurality of second linear conductors extending in a fourth direction different from the third direction and parallel to each other to intersect the plurality of first linear conductors,
the third direction is parallel to a direction in which the first feed line is connected to the first connection point, and
the fourth direction is parallel to a direction in which the second feed line is connected to the second connection point.

15. The antenna substrate according to claim 14, wherein the second and third planar radiation electrodes have the same mesh structure as the first radiation electrode.

16. The antenna substrate according to claim 1,
wherein each of the first to third planar radiation electrodes includes first and second sides opposed to each other in a direction of the first linear line, and third and fourth sides opposed to each other in a direction of the second linear line, and
a size of each of the first to third planar radiation electrodes is defined by a distance between the first and second sides and a distance between the third and fourth sides.

17. The antenna substrate according to claim 1,
wherein the first to third planar radiation electrodes are similar to each other when viewed in a thickness direction of the dielectric substrate, and
a size difference between the first to third planar radiation electrodes is determined by a similarity ratio.

18. The antenna substrate according to claim 1, wherein a size of the second planar radiation electrode is equal to a size of the third planar radiation electrode.

19. The antenna substrate according to claim 1, wherein the first and second linear lines are orthogonal to each other.

20. An antenna device comprising:
the antenna substrate according to claim 1; and
a grounding electrode on a side opposite to the main surface in the dielectric substrate.
